(19) United States
(12) Patent Application Publication
(10) Pub. No.: US 2013/0041792 A1
(43) Pub. Date: Feb. 14, 2013

(54) CALCULATION APPLICATION AND METHOD

(71) Applicants: Justin King, Hayward, CA (US); Laima Kardokas, Emerald Hills, CA (US)

(72) Inventors: Justin King, Hayward, CA (US); Laima Kardokas, Emerald Hills, CA (US)

(21) Appl. No.: 13/584,609

(22) Filed: Aug. 13, 2012

Related U.S. Application Data
(60) Provisional application No. 61/522,662, filed on Aug. 11, 2011.
(60) Provisional application No. 61/651,892, filed on May 25, 2012.

(51) Int. Cl. G06Q 40/00

(52) U.S. Cl. 705/30

(57) ABSTRACT

Embodiments of the present invention provide a solution for generating interactive cost saving reports on card programs offered to customers. In one embodiment, a method comprises receiving, at a computing device (e.g., a mobile device), characterization data associated with an entity, determining a benchmark data source corresponding to the characterization data, and receiving benchmark data from the determined benchmark data source. The method continues by calculating financial benefit values from the benchmark data and characterization data, generating an interactive savings report, wherein the interactive savings report includes summarized data of the calculated financial benefit values, and displaying the interactive savings report including a plurality of visual metrics corresponding to the summarized data of the calculated financial benefit values, wherein the plurality of visual metrics are interactive.

### CROSS-REFERENCES TO RELATED APPLICATIONS

This application claims priority to U.S. Provisional Application No. 61/522,662, filed on Aug. 11, 2011, titled, “Calculation Application and Method,” by King, et al., and U.S. Provisional Application No. 61/651,892, filed on May 25, 2012, titled “Calculation Application and Method,” by King, et al., the entire contents of which are both incorporated herein in their entirety.

### BACKGROUND

Partnerships between banks, businesses and credit card associations have allowed for numerous special incentive credit card programs to develop. Presently, credit card associations offer various programs to financial institutions, which allow those institutions to reduce prices in certain areas of the market for their customers. Each program can offer cost savings benefits which are tailored to a specific areas interest, such as travel, shopping, gasoline and refunds (e.g., cash back), amongst others. Each program is not only developed based on the credit from these partnerships, but also based on the geographical location of the banks and businesses and the current market values.

With the amount of card programs available on the market at any given time, companies may not be able to determine which program offers the best return and savings for that company. Similarly, the company may have specific needs which are not found within the current programs being offered on the market. Each company differs from another in various aspects, such as, for example, purchasing power, number of employees, geographic location, currency utilized, travel expenditures, etc. Accordingly, card programs offered by an issuer that provides the most cost efficient solution for one company may not provide the most efficient solution for another. For example, a worldwide consulting firm may need its employees to travel frequently, while a regional restaurant company may need little to no travel for the majority of its employees. Accordingly, a card program that provides travel incentives and savings may provide the maximum savings for the consulting firm but may provide very little financial benefits for the regional restaurant company. Accordingly, there is a need to identify and analyze the savings related to a card program for a particular company in a quick, efficient, and accurate manner.

In some cases, a company may already employ a specific card or card program and may not be aware of more beneficial cards and programs available to them. Due to the number of card associations and programs offered by issuers, each company may wish to easily decipher which program is the best fit based on a plurality of attributes specific to that company. Accordingly, there is a need for a tool that may be provided to representatives of issuers or payment processing networks as well as representatives of potential client companies in order to quickly, efficiently, and accurately determine the savings that implementing a particular card program may provide an organization based on their spending data, purchasing history, operations, etc.

Accordingly, what is needed is a simple solution to facilitate card program selection by customers and corporation which calculates a company's expenditures to determine more optimal savings with card programs offered.

Embodiments of the present invention address these and other problems, individually and collectively.

### BRIEF SUMMARY

Embodiments of the present invention relate to a technological tool used by representatives of a financial institution (e.g. issuers, payment processing networks), to aid in selling a card program to end users (corporate or businesses client as well as individuals) in order to quickly, easily, and efficiently show the value proposition of a card program to an end customer based on information about the customer's business, spending, and/or operations. The tool may be implemented through systems and methods for generating interactive cost saving reports regarding payment card programs offered to customers and corporations. In further embodiments, a customer or corporation may wish to determine if a new program can be provided by an issuer to cater to the specific needs of that company. Additionally, by providing an interactive savings report, representatives of the entity can easily see the impact a card program can have on working capital, profit margins, and the balance sheet of the company. Accordingly, the company can easily see the financial benefits of making changes to their processes, procedures, and operations over a predetermined time period.

In one embodiment, a method comprises receiving, at a computing device (e.g., mobile device), characterization data associated with an entity, determining a benchmark data source corresponding to the characterization data, and receiving benchmark data from the determined benchmark data source. The method continues by calculating financial benefit values from the benchmark data and characterization data, generating an interactive savings report, wherein the interactive savings report includes summarized data of the calculated financial benefit values, and displaying the interactive savings report including a plurality of visual metrics corresponding to the summarized data of the calculated financial benefit values, wherein the plurality of visual metrics are interactive.

In another embodiment, a computing device (e.g., mobile device) may comprise a processor and a computer readable medium comprising computer code for implementing a method comprising receiving, at a computing device (e.g., mobile device), characterization data associated with an entity, determining a benchmark data source corresponding to the characterization data, and receiving benchmark data from the determined benchmark data source. The method continues by calculating financial benefit values from the benchmark data and characterization data, generating an interactive savings report, wherein the interactive savings report includes summarized data of the calculated financial benefit values, and displaying the interactive savings report including a plurality of visual metrics corresponding to the summarized data of the calculated financial benefit values, wherein the plurality of visual metrics are interactive.

These and other embodiments of the technology are described in further detail below.

### BRIEF DESCRIPTION OF THE DRAWINGS

FIG. 1 illustrates an exemplary system for utilizing a cost savings calculation application provided in embodiments of the present invention.

FIG. 2 illustrates an exemplary flow diagram of steps for implementing the cost savings calculation application utilized in embodiments of the present invention.

FIG. 3 illustrates an exemplary screenshot for initializing use of the cost savings calculation application by a user in one embodiment.

FIGS. 4A-4B illustrate an exemplary screenshot of a new scenario interactive graphic that allows a user to input entity information and select a program type for a new interactive savings report.

FIG. 5 illustrates an exemplary screenshot of a scenario section and a scenario sub-section of an interactive savings report to provide characterization data for a purchasing card program.

FIG. 6 illustrates an exemplary screenshot of a scenario section and an invoices sub-section of an interactive savings report to provide characterization data for a purchasing card program.

FIG. 7A-7C illustrate exemplary screenshots of a scenario section and a payment types sub-section of an interactive savings report to provide characterization data for a purchasing card program.

FIG. 8 illustrates an exemplary screenshot of a scenario section and a volume achieved by year sub-section of an interactive savings report to provide characterization data for a purchasing card program.

FIG. 9 illustrates an exemplary screenshot of a volume growth section and sub-section of an interactive savings report to display potential card volume based on information entered in the scenario section shown in FIGS. 5-8 for the purchasing card account.

FIG. 10 illustrates an exemplary screenshot of a source of financial benefits section and financial assumptions sub-section of an interactive savings report to display characterization data and benchmark data used to define financial assumptions on which calculations are based for the purchasing card account savings report.

FIG. 11 illustrates an exemplary screenshot of a source of financial benefits section and potential financial benefits sub-section of an interactive savings report to display the potential cost savings based on the characterization data and benchmark data used to calculate the cost savings and provide source information corresponding to the savings for the purchasing card account savings report.

FIG. 12 illustrates an exemplary screenshot of a potential financial benefits section and sub-section of an interactive savings report to display potential financial benefits for the purchasing card account based on characterization data provided by a user and benchmark information over a predetermined time period.

FIG. 13A illustrates an exemplary screenshot of an interactive savings report after calculations are performed by the cost savings calculation application implemented in FIG. 1 for a purchasing card account.

FIG. 13B-13E illustrate exemplary screenshots of an interactive savings report after calculations are performed by the cost savings calculation application implemented in FIG. 1 for a purchasing card account.

FIG. 14A-14B illustrates exemplary screenshots of a volume growth section and sub-section of an interactive savings report generated by a cost savings application based on characterization data and benchmark data.

FIG. 15A-15C illustrates exemplary screenshots of a final report generated by the cost savings application based on characterization data and benchmark data provided by a user.

FIG. 16 illustrates a block diagram of an exemplary transaction system related to the cost savings calculator application.

FIG. 17 illustrates a block diagram of an exemplary embodiment of a mobile device as illustrated in FIG. 1.

### DETAILED DESCRIPTION

Embodiments disclosed herein are directed to a computer implemented system and method for generating interactive savings reports related to card programs for companies using known spending data for a company. Specifically, the present invention provides a computer program product, or application, that can be utilized by an issuing financial institution which offers card programs to clients. Many of the embodiments below discuss mobile devices, but embodiments of the invention can include any suitable type of computing device. Utilizing the application, a user may provide a plurality of characteristics for the company including spending history, invoicing information, and any other relevant information about the operations of a company, in order to generate an interactive savings report showing the available savings a card program may provide a company. The report may provide a comparison of programs offered to the company along with calculations of the savings and benefits offered by each program. The report can provide not only calculations of multiple card programs, indicating the proposed best fit program for the company, but the report can also provide calculations of more than one card type, for example, a corporate card or a purchasing card. In some embodiments, the application can be utilized for payables automations programs as well as any other similar program that may be introduced by a company.

Interactive reports can be generated which provide savings calculations based on the spending patterns, current purchasing procedures, or any other current operations data of a company that explain the savings a business may receive through various card programs offered by partnering banks and card associations. Card programs can offer companies cost saving methods through both financial benefits from rewards and lower financing and transaction fees for specific types of purchases. The savings provided in the report can be calculated based on known card program and industry information (benchmark data) and company specific information gathered from a representative of that company (characterization data).

Using the company specific characterization data along with the industry benchmark data, an interactive savings report can be generated that provides a summary of the cost savings that implementing a particular card program may provide over a predetermined period of time and the source of the cost savings. For example, if a user implements a purchasing card program, the user may be able to see an “x” amount of savings over a “y” period of time due to returns on incentives for, for example, travel, room and board, food, etc. These savings and incentives can be seen by a user through interactive graphics. Accordingly, the user can modify the results in the interactive savings report in order to view corresponding changes in the calculated results and characterization data. The modifications directly change the output of other graphs and the interactive savings report as a whole. Accordingly, users can immediately see the effect that different inputs have on the financial benefits received and may quickly and easily change the input information to show a number of different scenarios or savings situations that may be available under the program.

For example, a user may enter information that is representative of their current spending activity but may not know how many of their purchases they can reasonably convert to a purchasing card over the next three years. As such, they may use a benchmark data input based on an average company in their industry to determine what their savings would be if they converted an average percentage of their purchases (e.g. 50%) under the new card program. For example, they may determine that this may save them one million dollars over the next three years. However, the user may also interact with the interactive savings report to determine how much would be saved if they converted a higher (75%) or lower (25%) percentage of purchases over the next three years. Additionally, the user may be able to determine what percentage would need to be converted if they wanted to save two million dollars over that period of time. Accordingly, embodiments of the present invention may provide a quick and easy method of setting institutional goals or conversion targets to the user and show the benefits of implementing such institutional constraints or policies. Accordingly, end users are provided a clear and effective report that sets goals for their organization, and shows the benefits they may receive if successful.

Embodiments of the present invention provide a number of technical advantages including providing fast, efficient, effective, and accurate estimates of cost savings for card programs based on spending information of a company in an interactive and modifiable report. Additionally, the interactive aspects of the report provide non-obvious benefits including allowing a user to interactively engage with a set of institutional goals and determine which factors of the corporations operations, costs, and behavior lead to the greatest cost savings over time. Embodiments of the present invention allow users to interactively set goals, track their progress such that they can adjust their goals and processes as time passes, and share the cost savings with other individuals within the organization quickly and easily. Additionally, in some embodiments, the cost savings calculator program may be implemented on a portable device so that a representative of a financial entity may visit a client with the cost savings calculator on a portable device. The portable device allows the representative to demonstrate the financial benefits of programs they are promoting through a simple, user friendly, and interactive format.

However, prior to explaining the example embodiments of the invention in more detail, a further description of some terms can be provided for a better understanding of the invention.

In embodiments of the present invention, “characterization data” may include any data that describes or portrays an entity or an entity's operations. For example, the characterization data may be associated with an entity and may comprise entity information and information related to the type of savings report selected by a user during the use of the cost savings calculation application. Accordingly, characterization data may comprise information about the financial size (e.g. annual revenue, market capitalization, etc.), location, business sector, industry, number of employees (e.g. employee count), preferred currency, etc. of an entity as well as invoice information, expense information, or any other type of information related to the type of savings that is being calculated. Additionally, the characterization data may be directed to personal finances of an individual and may not be limited to an entity that is a corporation.

In embodiments of the present invention, “entity information” may include any information about an entity and/or the entity's operations. For example, entity information may comprise information about the financial size (e.g. annual revenue, market capitalization, etc.), geographic location, business sector, industry, number of employees (e.g. employee count), preferred currency, or any other information that relates to the operations of an entity. The entity information may be exact, approximate, or may be provided in general categories (e.g. employee count may provide a large corporation option (5000+ employees)).

A “entity” may include any business, corporation, individual, or other organization that may engage in purchasing goods, invoicing expenses, or may benefit from a card program offered by a financial institution. The entity may be represented by an agent or a third party associated with the entity that has the authority to enter the entity into a program or contractual engagement with a financial institution. Additionally, embodiments of the present invention are not limited to financial institutions alone and may be used by any suitable service provider to calculate cost savings for a potential client. A “client” may include an entity for which the cost savings calculator program is being utilized. The client can include any company, individual or other end-customer for which cost savings are being calculated.

In embodiments of the present invention, “information related to the type of savings report selected” may include any information that is relevant to the cost savings calculation that the cost savings calculator application is performing. The information that is relevant to the savings calculation may change depending on the type of interactive savings report that a user selects. According to embodiments of the present invention, the “type of interactive saving report” may include any type of program that provides benefits or incentives to users. For any type of program a cost savings analysis can be applied to determine a best fitting program with maximum savings based on client characterization data and where goals can be set to receive maximum savings. For example, the types of interactive savings reports may include a purchasing card program, a payables automation program, or a corporate spending card program.

Other types of interactive savings reports may be implemented in embodiments of the present invention and the present invention should not be limited to only those examples described herein. Additionally, the type of interactive savings report may include any other type of cost savings analysis for any other types of programs including other commercial card programs or card programs selected for a particular region, for example, the Agro card program in Brazil. Additionally, card programs could be directed to prepaid card programs, distribution card programs, and any other type of program that provides benefits to users and a cost savings analysis could be applied to compare current activities and savings that could be provided.

Additionally, the type of interactive savings report selected may be based on a type of payment device (e.g. corporate spending card, purchasing card, prepaid debit card, etc.) selected. A payment device may include a portable device that may be used to affect payment or complete a transaction. For example, a payment device may include a credit card, pre-paid debit card, a phone equipped with a payment account, radio frequency identification (RFID) chip equipped device, etc. Alternatively, the type of interactive savings report may be independent of the type of payment device selected. For instance, the type of savings report selected may depend on the specific incentives tied to a particular payment device (e.g. providing a choice between a miles program and a cash-back program using the same corporate spending card) or there may be no specific payment device (e.g. payables automation program).

The information related to the type of interactive savings report selected may vary depending on the selected type of interactive savings report. For example, the information may include invoice information if the cost savings calculator application is performing a purchasing card program or a payables automation program cost savings analysis. In embodiments of the invention, “invoice information” may include, for example, a total number of invoices processed annually, an average size of an invoice, a current purchasing program spending volume, current payment methods, costs involved with each current payment method, and volume of payments made for each current payment method, percent of each payment method that could be converted to a purchasing card program, an average card days payable, an average non-card days payable, a short-term interest rate, a supplier discount, and an issuer rebate. However, the invoice information may also include any other data relevant to a savings calculation, depending on the incentives provided by the card program.

Alternatively, the information related to the type of interactive savings report may include spending information if the cost savings calculator application is performing a corporate spending card program savings analysis. In embodiments of the present invention, “spending information” may include, for example, an entity's total annual spending on travel, current corporate card program spending, percent of travel budget spent on airfare; lodging; auto rental; food; entertainment; and miscellaneous sources, as well as spending conversion targets for predetermined time periods, total manual expense reports processed annually, percent of manual expense reports that could be automated, total cash advances processed annually, percent of cash advances that could be eliminated, supplier discount, and issuer rebate. However, the spending information may also include any other data relevant to the savings calculation depending on the incentives provided by the card program.

An “interactive savings report” may include a generated collection of data in a specified format (e.g. a template or customized format) that indicates or summarizes the amount of savings based on input data. The interactive savings report may include calculated financial benefit values, summarized data corresponding to the calculated financial benefit values, a plurality of interactive visual metrics corresponding to the summarized data of the calculated financial benefit values, characterization data about the entity, benchmark data, a determined benchmark source, or any other information that is beneficial to a user of embodiments of the present invention. The interactive savings report may be viewable on a display of a mobile device, may be interactive, may be electronically transferable, and may be capable of being stored, printed, re-formatted, customized, and modified. The report can be in various languages and currencies. The interactive savings report may comprise sections and sub-sections where information may be entered for a particular type of input for each section or sub-section.

In embodiments of the present invention, “financial benefit values” may include monetary benefits calculated using information about an entity. For example, the financial benefit values may be determined during the cost savings calculation of a card program based on the benchmark data and characterization data associated with an entity. The financial benefit values may be determined over a set period of time, for example, annually, monthly, quarterly, etc., or may be provided in a single lump sum. Accordingly, the financial benefit values may be personalized for a particular entity or may be generalized for a particular sector, industry, etc., depending on the amount of characterization information provided in the calculations. For example, financial benefit values could be provided for an entity using the exact characterization data corresponding to the current operations of the entity in order to determine exactly how much the entity would save. Alternatively, financial benefit values could be calculated using almost exclusively benchmark data (averages for companies within a sector, industry, geographic area, etc.) in order to determine the average amount a company in that sector, industry, or geographic area would save implementing the program.

In embodiments of the present invention, “visual metrics” may include any perceived standard of measurement. The visual metric may be displayed on a screen of a mobile device and the visual metric may be interactive such that a user may interact, modify, or change the position or measure of the visual metric. An interactive savings report may include a plurality of visual metrics corresponding to summarized data of the calculated financial benefit values. For example, the visual metric may be a bar graph that indicates the amount of financial benefits an entity may gain by implementing a particular program in the first year. The visual metric may be interacted with by a user such that the user may move the top of the bar graph to a new value. Modifying the visual metric to move the financial benefits value to a new value for the amount saved in the first year may change the characterization data, providing a goal or operations setting that would result in updated financial benefit values as set by the user input. Accordingly, the user may interact with the visual metric in order to change the characterization data to updated characterization data and updated financial benefit values may be calculated, resulting in an updated interactive savings report.

In embodiments of the present invention, “user input” may include any input by a user to a mobile device. The user input may be received by the mobile device through any suitable means including through any suitable input element. For example, the mobile device may receive the user input through a touch screen input, receiving a command through a microphone, receiving a command through an input keyboard, or any other suitable input method. Additionally, the user input may be received through an antenna where the user input is sent over a communications protocol or communications network (e.g. may send a command through a Bluetooth™ device, through the internet, etc.).

In embodiments of the present invention, “updated characterization data” may include characterization data that has been modified by a user input through the mobile device using the interactive visual metrics of an interactive savings report. The characterization data may be changed when the user input changes the characterization data that was originally input or when the user input changes the summarized data of the calculated financial benefit values that are displayed in the interactive savings report through visual metrics. In the first case, the user input directly changes an aspect of the characterization data and updated financial benefit values are calculated based on the updated characterization data. In the second case, the modifying of the visual metrics changes the calculated financial benefit values which are directly tied to the characterization data that was used to calculate the financial benefit values. Accordingly, when the visual metrics are changed and the financial benefit values are updated, the characterization data may change as well to match the updated financial benefit values. Accordingly, the updated characterization data is determined by the modification of one or more of the interactive visual metrics in the interactive savings report which results in changing the characterization data to match the updated financial benefit values. Either way, the user input interacting with the one or more of the plurality of visual metrics, results in updated characterization data for the entity. Additionally, the type of characterization data that may be updated may be limited by a user or by the type of data. For example, the sector, geographic location, and other entity information may not be updated by the user input applied to a visual metric. Instead, information related to the type of savings report selected may be the characterization data that is updated because it is the information that is most likely to be changed depending on business operations, procedures, expenses, and other controllable inputs.

In embodiments of the present invention, “updated financial benefit values” may include the recalculated financial benefit values after a user input has modified the characterization data in the interactive savings report. For example, the financial benefit values may be updated when the user input interacts with one of the plurality of visual metrics to provide updated characterization data which in turn updates the financial benefit values, or the user input may change the summarized data of the calculated financial benefit values to provided updated financial benefit values directly.

A “final savings report” may include an interactive savings report that has been re-configured such that it cannot be edited. For example, the finished savings report may include a report that has been converted to an Adobe™ pdf™ file such that a user can no longer interact with the finished savings report to update the characterization data and subsequently the financial benefit values. The final savings report may be sent to a representative of an entity or may be sent to any other decision maker at an entity to review any of the information included in the interactive savings report but in a final version that may indicate the desired solution after all other programs have been analyzed, or may provide multiple different options to be reviewed by an entity at a later time.

“Benchmark data” refers to data which is previously stored and/or accessed by a user of the application on the mobile device and is not related to a particular entity. The benchmark data can include, for example, market data such as average costs for a particular type of business, industry, or size of company to pay an invoice, pay a charge through a purchasing card program, average short term interest rates based on geographic location, size of company, amount of debt, etc., present exchange rates for currencies, any other relevant market data, business rules, and business metrics. Accordingly, the benchmark data can be customizable by any of the aforementioned entities prior to or after download of the application on the mobile device and may be received from a benchmark data source. The benchmark data can be customized prior to the generation of each individual report for a client company, after download of the application by a user onto the mobile device. The benchmark data can include default data and settings.

A “benchmark data source” may include any publication, association, trade group, or other organization that provides information related to any of the types of savings report options provided to a user. For example, benchmark data sources may include reports from RPMG™, Deloitte™, and Accenture™ regarding various surveys of business executives regarding costs in their industries, geographic regions, etc. These resources may be downloaded onto a memory element or computer readable medium on the mobile device so that the benchmark data sources and benchmark data may stay updated. As new types of savings reports that are offered by the cost savings calculation become available, new benchmark data sources may be implemented into the cost savings calculator program to ensure information is present that may be used by the cost savings calculator program to calculate costs related to a type of cost savings report offered.

A “mobile device” refers to any device which is capable of being transported to various geographical locations of companies in order to collect company related data for calculation and subsequent generation of a report. The device can be capable of downloading a cost savings calculator program or can be capable of accessing the program remotely (e.g. through the Internet). The mobile device may include a computing device (e.g. a laptop or tablet computer), a cellular device (e.g. a phone or smartphone), or a personal digital assistant (e.g. a Blackberry™ device).

A “card program” may include a solution offered by a partnering institution, (e.g. a bank) and a credit card association (e.g. a payment processing network) which provides at least one incentive for a user of a payment device. The program can offer lower finance rates, cash incentives, frequent flyer miles, rebates at select merchants, and variety of other rewards in combination or alone. In some embodiments, a card program refers to a solution offered by an entity (e.g. a payment processing network, a bank, a third party invoice processor, etc.) that can provide end-to-end services for processing transactions and can offer a service with incentives for payables automation program. A payables automation program is a commercial solution which resolves invoice processing and purchase order inquiries between buyers and supplier. The payables automation program may shift all transaction processing between buyers and suppliers to the payables automation program provider such that the buyers and suppliers can minimize the overhead associated with processing invoices and other transactions internally. Further details of accounts payable systems that could be incorporated into the above-described accounts payable systems can be found in U.S. Patent Publication Nos. 20090112661 to Mullen et al., and 2011055079 to Meany et al.

A “server computer” typically refers to a powerful cluster of computers. For example, the server computer can be a large mainframe, a minicomputer cluster, or a group of servers functioning as a unit. In one example, the server computer may be a database server coupled to a Web server.

A “user” can be any individual who is operating the cost savings calculator program. The user may manually input data including selecting benchmark data and characterizing data for a client company or the cost savings calculator program may receive this information directly from a client server computer or database. A user can include a representative from the cost savings calculator program designer or an individual from the issuer, credit card association, or payment processing network who is authorized to utilize the cost savings calculator program. In some embodiments, the user may be an employee of the client company for which the program is being utilized.

### I. Exemplary Systems

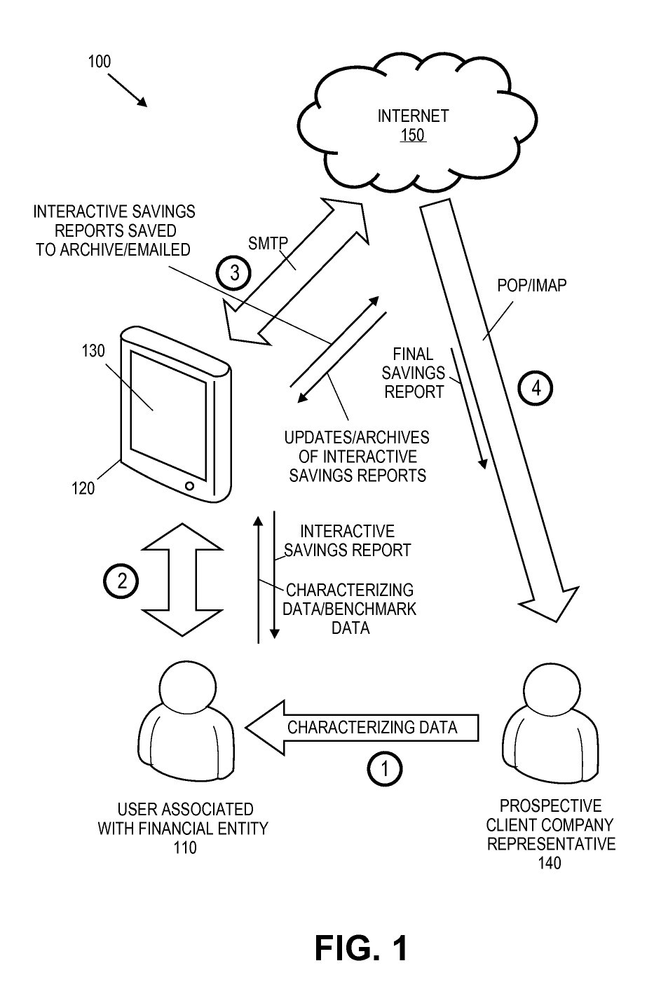

Referring now to FIG. 1, an exemplary system 100 for providing a cost savings calculator program 130 operated by a mobile device 120 to generate an interactive savings report for a prospective client company representative 140 is illustrated. As shown, a user 110 which is utilizing the cost savings calculator application 130 can visit a prospective client company representative 140 to provide the cost savings calculator service 130 for the prospective client company representative 140. The user can bring a mobile device 120 (e.g. tablet computer), which includes the cost savings calculator application 130 and is capable of wireless communication with a network 150 (e.g. internet). Prior to visiting the prospective client company representative 140, the user 110 can select benchmark data for utilizing with the prospective client company 140 or may select a benchmark data source (e.g. a publication of relevant cost information by a trade group in the prospective client company's industry) that is relevant to the prospective client company 140. Additionally, the benchmark data source may be selected automatically based on entity information entered during operation of the cost savings calculation analysis.

The cost savings calculator software 130 may be designed in conjunction with a financial institution (e.g. issuer, payment processing network, or credit card association) in order to input various incentives and rules offered by a financial entity that correspond to offered card programs by that financial entity. The card programs may include purchasing card programs, corporate card programs, payables automation programs and any other payment program known in the art. The cost savings calculator program can be provided to prospective client company by a representative user associated with the financial entity having a mobile device 120 capable of storing and running the cost savings calculator application 130. In some embodiments, the cost savings calculator application 130 can be provided through a communication medium (e.g. the internet) as well. Prospective client company representatives may herein be referred to as clients, corporations, consumers, and/or cardholders.

In step 1, the user 110 may run the cost savings calculator application 130 on the mobile device 120 and receive characterization information from the prospective client company representative 140 in order to input information associated with the prospective client company 140 into the cost savings calculator application 130. The application may allow the user 110 to begin a new interactive savings report for the prospective client company and to input initial criteria, such as the type of interactive savings report being generated (e.g. a purchasing card or a corporate card). This information can depend on the entity information made known to the user associated with the financial entity by the prospective client company representative. As explained above, the entity information may comprise a company's financial size, employee size, etc.

The cost savings calculator application 130 can then generate a series of questions which the user associated with the financial institution relays to a representative of the client company 140. The questions can be targeted towards the selected or desired card program such that the user associated with the financial entity receives information related to the type of savings report selected. The prospective client company representative may supply as much or as little characterization data to the user associated with the financial entity as they desire. However, the more characterization data provided by the prospective client company representative, the more tailored and accurate the interactive savings report may be. For any information that is not provided or not known by the prospective client company representative 140, the cost savings calculator application may use benchmark data from a determined benchmark data source that is most closely associated with the industry, size, geographic location, etc. of the prospective client company. Accordingly, if the prospective client company representative would like to know what the average savings in their industry may be for a particular card program, the cost savings calculator could provide such an interactive savings report. Furthermore, the cost savings calculator application may generate such an interactive savings report by using benchmark data received from a determined benchmark data source that most closely corresponds to the characterization information provided by the prospective client company representative or is closest to the industry, geographic location, and other publicly available information about the prospective client company.

In step 2, the user 110 can input characterization data provided in the responses to the questions by the prospective client company representative 140 into the cost savings calculator application 130 through an input device, such as a keyboard, a mouse, a microphone, or a touchscreen of the mobile device 120. For any information that is missing, the user 110 may either choose a benchmark data source or the benchmark data that most closely matches the prospective client corporation. Additionally, the user may not have to choose anything and the benchmark data may be entered by default with the option to be changed by the user. After all the characterization data including the responses to the questions, benchmark data, and any additional data related to the cost savings calculation analysis is entered, the application can generate an interactive savings report of the card programs which offer the best incentives and cost savings to the client company. The interactive savings report may be displayed on the mobile device and the user associated with the financial entity may either show the prospective client company representative the interactive savings report or may send the interactive savings report to a device being used by the prospective client company representative 140. Either way, the user and/or prospective client company representative may now have access to the calculated financial benefits information determined by the cost savings calculator application. Additionally, the prospective client company representative or the user may have access to the interactive savings report in order to interact with the financial benefit information and characterization data in order to modify the results.

In step 3, the interactive savings report can be communicated, e.g., through SMTP, via a wireless communication medium, such as Wi-Fi or a cellular communications network, to the Internet or other communication network. A central server (not shown), which is also in communication with the Internet or other communications network, can then store or archive the interactive savings reports for later use. The interactive savings reports may then be requested by users or prospective client representatives in the future to further modify the savings report.

In step 4, the interactive savings report can be sent via the Internet in an electronic communication to the client company, for example, through POP/IMAP messaging. In further embodiments, the interactive savings report can also be displayed on the interface of the mobile device for the user and the representative of the client company to view. In some embodiments, the interactive savings report may be converted into a final savings report and sent to the prospective client company representative or other representatives of the prospective client company so that other decision makers can see a report of the savings associated with particular card programs.

### II. Exemplary Methods for Generating Interactive Savings Reports

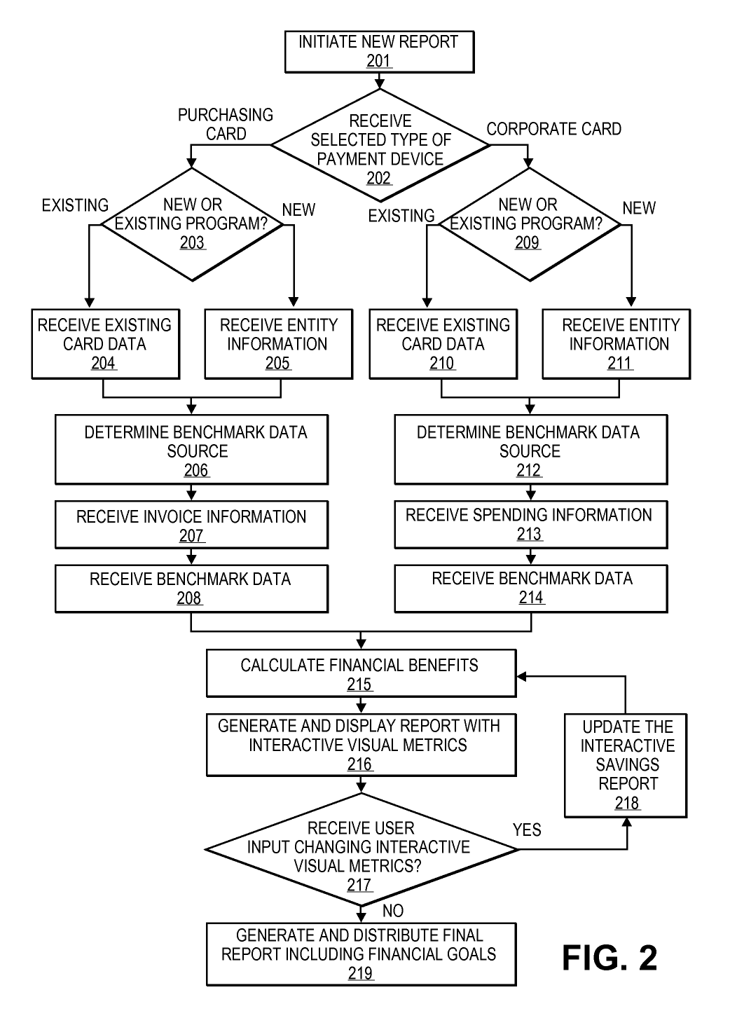

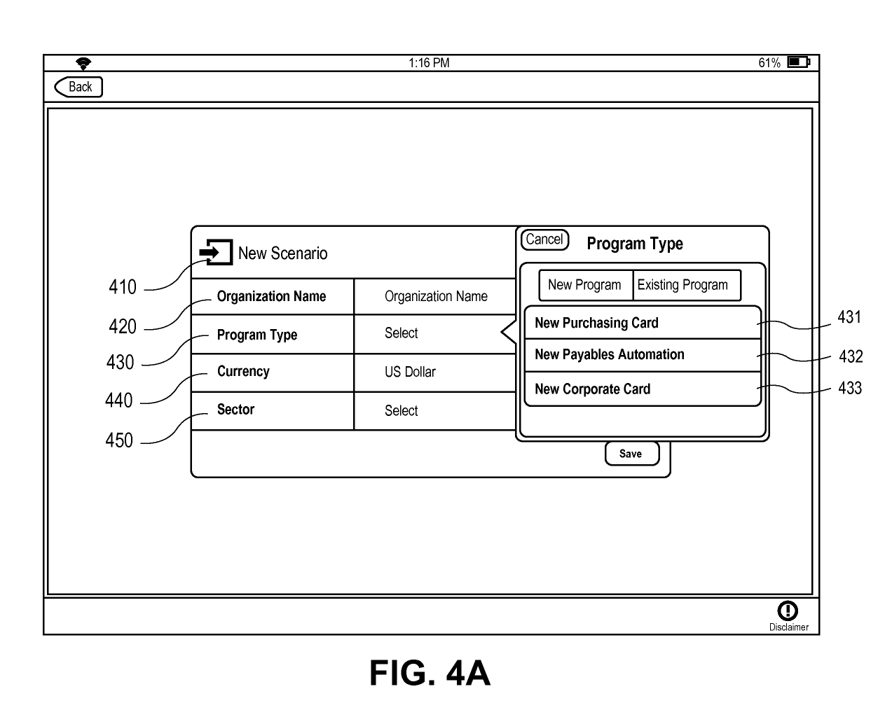

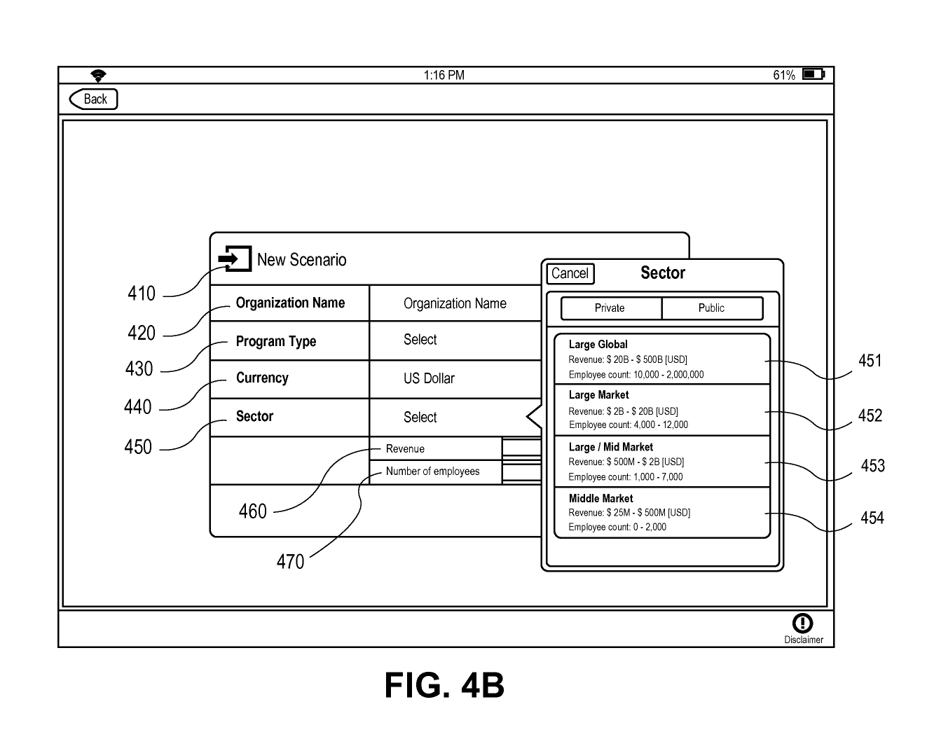

The details for generating the aforementioned interactive savings report and calculating cost savings for a card program are further described with reference to the flowchart in FIG. 2. The flow diagram in FIG. 2 can be implemented on a mobile device (shown in FIG. 1) and each step can be provided in a different screen of a user interface on the mobile device or multiple steps may be performed on a single screen of a user interface on the mobile device. Additionally, each step shows an input of a user from the perspective of the application or a question for a user to answer (e.g. “New Card of Existing Card?” corresponds to a user input in the cost savings calculator application). The steps of FIG. 2 are described with references to FIGS. 4A-15C which are screenshots of the user interface displayed on a mobile device during the generation of an interactive savings report according to embodiments of the present invention.

Prior to the flowchart steps shown in FIG. 2, a user can register with the cost savings calculator application server after downloading the application onto the mobile device shown in FIG. 1. In some embodiments, such as if the service is only provided through the Internet, a client user may also create an account in order to access the service. Any information may be provided and stored about the user associated with the financial entity or the client user during registration. The user may provide a preferred or default language which may be selected from a list of available languages or may select to utilize an “other” language, which may be provided by a third party if not currently available in the cost savings calculator application library. After setting a language for the user profile, the user is then directed to an initial screen of the cost savings calculator application program where the user can be directed through an initial set of inputs to define a client profile for a report.

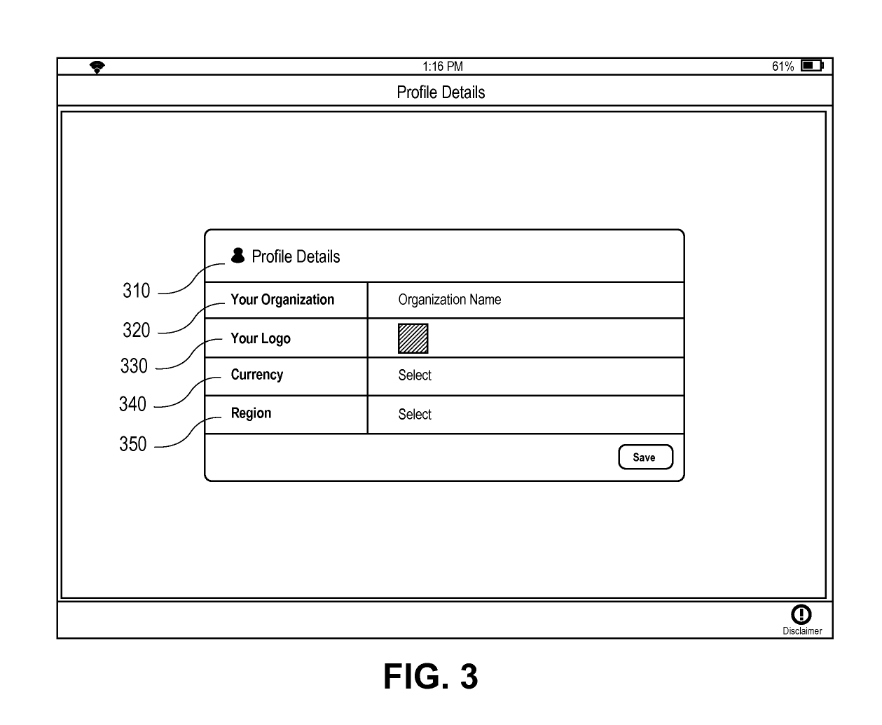

For example, an exemplary screenshot of a user interface for defining a new client profile is shown in FIG. 3. As shown in FIG. 3, a client profile 310 may comprise information such as the client or organization name 320, the name of the representative, or any other identifying information. The user can then upload a logo 330 of the company with which he/she is running the report in order for that logo 330 to appear on all reports generated for the client. The user can also update the logo 330 at any time. The user can also enter a currency 340 for the client, or organization for which the program is being utilized. Additionally, the user can enter a region or geographic location 350 in which the client is located such that card programs offered within that region 350 are utilized to perform the cost savings calculations. Any other information including contact information, marketing preferences, etc. may be stored about the user. After completing the initial setup of the client profile 310, the user can then be directed to a screen of the application which provides options for the user to, for example, create a new project, e.g., a start a new customer report. As well, the user can be provided with the option to access and view past, or previous reports.

In step 201, the user may initiate the generation of a new interactive savings report. If the user has not already provided the client company information the user can be directed to enter profile details as explained above. Additionally, if the user has not generated any reports through the program previously (e.g. is a new user) or desires to begin a new report (e.g. a new cost analysis or a new project), the application can provide the user with a series of options to begin setting up and generating an interactive savings report. The user can then be provided with a user interface providing questions to be answered by the user as shown in exemplary screenshots of FIGS. 4A-4B, which provides the user (client) set-up of initial report or new scenario details 410. However, if the user already has an existing account and has previously generated reports through the cost savings calculator application, the user can select open previous report, in order to access a report that has previously been archived, or stored locally on the mobile device, or communicated to and stored on a central server of the cost savings application service provider.

In step 202, the cost savings calculator application may receive a selected type of interactive savings report to generate. The selected type of interactive savings report to generate may be related to a type of payment device selected (purchasing card vs. corporate card) or may be independent of the payment device (payable automation). As shown in the screenshot of FIG. 4A, the user can be provided with a program type 430 option, offering card types including, for example, a corporate card 433, a purchasing card 431, or a payables automation 432 program. The type of program selected 430 may determine the type of savings report that is generated. These programs types, can be displayed in a pop-up window (as shown) or entered manually (e.g. via keyboard input) to the field. Other characterization data, specifically entity information that may be relevant to any type of interactive savings report, may also be entered at this step. For example, as shown in FIG. 4A, the new scenario tab 410 may not only ask the user for the type of program the interactive savings report will be generated for but also the organization name (or name of the report) 420, currency 440, and sector 450 of the entity to be used for the interactive savings report.

The type of program selected by the user may determine the type of savings report generated and may affect the calculations as well as the requested characterization information to be utilized for the interactive savings report. Each type of card or program caters to a particular type of business, which can be made known by the user to the prospective client company for which the report is being generated. After selecting a card type, the application can begin retrieving program data currently offered and potentially available for that card type or program type. Alternatively, the program data may be stored locally on the mobile device or may be requested and received from a server computer over a communications network.

An interactive savings report for a corporate card 433 type of program may show how much potential spending could be captured using a corporate card and the total potential cost savings that could be realized over a predetermined period of time. The sources of cost savings comprise financial benefit values including savings from automating expense reports, eliminating cash advances, providing supplier discounts, and providing an increased rebate.

An interactive savings report for a payables automation 432 type of program may show how much potential spending could be captured by implementing payables automation and the total potential cost savings that could be realized over a particular time period. The sources of the cost savings may comprise financial benefit values including savings from process cost reduction, working capital optimization, supplier discounts, and increased rebates.

An interactive savings report for a purchasing card 431 type of program may show how much potential spending could be captured using a purchasing card and the total potential cost savings that could be realized over a particular time period. The sources of the cost savings may comprise financial benefit values including savings from process cost reduction, working capital optimization, supplier discounts, and increased rebates. This is the type of program selected in the exemplary screenshots shown in FIGS. 4A-16C. However, any of these programs could have been shown as well as other programs as described above.

In step 203, the cost savings calculator application may ask a user if they would like to generate an interactive savings report for a new program or an existing program. Accordingly, the user can select to run the cost savings calculator application for existing card programs already implemented with the client or propose a new card program for a client.

In some embodiments, the new card program option may correspond to designing a custom card program for a client. If that is the case, the client may provide a large amount of characterization data and the cost savings calculator program may have limits that it may maintain as set by an issuer. Additionally, an issuer or other financial entity may need to review any program offered by the calculator application to determine it is viable and ensure that they agree to the terms of the program. Accordingly, the new scenario details can also allow programs to be generated which cater specifically to that company's spending habits, or to view programs available which are a best fit for that company. For larger corporations offering services or products in a particular area, a new program may be the best option. However, for a small business offering general services and spends across a variety of areas, a card program already offered may be the best option. However, interactive savings reports can be generated for both options, if desired.

In step 204, the cost savings calculator application receives a selection of creating a report for an existing program by the user and may prompt the user to provide existing card data corresponding to the existing program. The cost savings calculator may provide a number of options to the user for receiving the existing card data. For example, the cost savings calculator may prompt the user to answer questions regarding the spending limits, spending amounts, and any other information related to the type of existing card program that may be used to determine the client's current program implementation and spending or benefits being received. Alternatively, the cost savings calculator may contact a server computer and database of card holder information at a payment processing network or issuer and may download the information related to the account. Additionally, the cost savings calculation application may have a credit card swiping input device that may allow a user to swipe their card and automatically contact the database of card holder information based on the credit card information received by the swiped card.

In step 205, the cost savings calculator application receives a selection of creating a new interactive savings report for a new program by the user and may prompt the user to provide characterization information including entity information. As explained above in regards to the selection of the type of interactive savings report that is to be generated, this step may be part of the card program selection step as well. FIG. 4A shows such an implementation. As shown in FIG. 4A, the user may be prompted to enter entity (client) information that may be relevant to the type of interactive savings report selected. For example, as shown in FIGS. 4A-4B, the new scenario tab 410 may not only ask the user for the type of program the interactive savings report will be generated for but also the organization name (or name of the report) 420, currency 440, and sector 450 of the entity to be used for the interactive savings report. The sector 450 can include various markets in which the client can be categorized such as, large global 451, large market 452, large to mid-size market 453, and middle market 454. A pop-up window (as shown) can provide the various sectors for which the current card program type serves. The categories are based on annual revenue 460 and employee count 470 for the client for whom the new scenario is being created. Alternatively, in some embodiments, the annual revenue 460 and employee count 470 of the client may be entered and the program may determine the appropriate sector 450 setting.

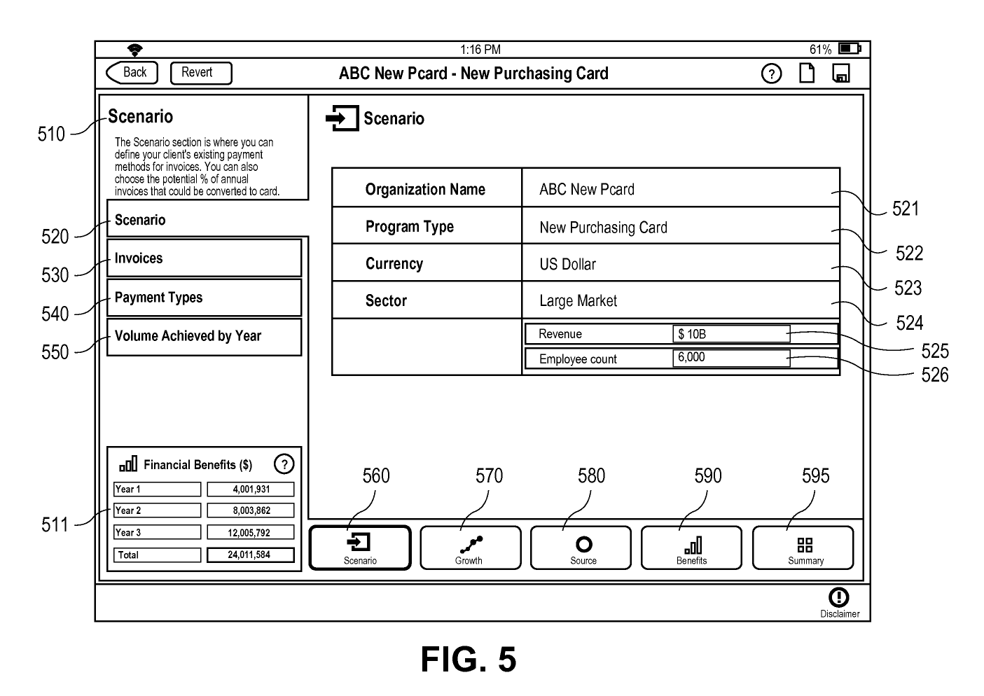

In step 206, the cost savings calculator application determines a benchmark data source corresponding to the received characterization data. Specifically, the entity information received from the existing card data, or from the user in step 205 above, may be used to determine the benchmark data source. Accordingly, entity information that has previously been provided to the calculator application (e.g. shown in FIGS. 4A-5) may be used to determine the benchmark data source. For instance, for the example provided in FIG. 5, the cost savings calculator may choose a benchmark data source that comprises information about Large Market companies whose primary currency is US dollars, who are located in the region provided in the profile generation step, that have revenue of roughly $10 Billion, and employ 6,000 people. Accordingly, a consultant report related to costs, processes, etc. for companies fitting this description may be selected as the benchmark data source for the interactive savings report. Furthermore, the benchmark data source may be determined without the user knowing or the user may be prompted to select a benchmark data source from a list of options.

Additionally, if the benchmark data source has not been updated for a long period of time or the cost savings calculator determines that the benchmark data source should be updated for any other reason, the benchmark data source may be updated by prompting the user for additional information or downloading the latest version of the applicable benchmark data source (e.g. a new report has issued since the last time the program was run for this card data).

The user can then be set up benchmark data to be utilized when generating reports. The user can be provided with options to change the benchmark source or use default settings. For users traveling to various geographic regions, the benchmark data source may vary for each new report generated. If a desired benchmark data is not provided within a default list, the user can be permitted to enter or to download another benchmark data source from a central server of the cost savings calculator service provider. The benchmark data source can be based on a geographical location or regions, as defined by currency, language, or other criteria.

The benchmark data source may provide specific finance information for each report. For example, the current card programs offered in the U.K. often differ from those offered in the U.S. Similarly, the value of the currency, gasoline and the stock market in each country can determine the finance rates and incentives available to a prospective client company if a new program is desired. For users implementing the application within a set geographic location, the default benchmark source selected during setup of the user account and profile may be saved and used to determine the benchmark data source. The benchmark data source may be determined using the country selected by the user as well.

In step 207, the cost savings calculator application may receive characterization data associated with the client, specifically, the characterization data received may be information related to the type of savings report selected. The type of information received at this point may depend on the type of interactive savings report selected in step 202. Because a purchasing card was selected, the cost savings calculator may ask for invoice information as the information related to the type of savings report selected.

As shown in FIGS. 5-9, the user may be taken through a set of interactive graphics, each of which has sections (e.g. 520-550 in FIG. 5) for which a user can input characterization data to calculate the potential cost savings based on client specific cost inputs. The input options provided can be pre-generated based on the type of interactive savings report selected previously as well as whether the card program is for an existing or new program as discussed in the previous paragraphs. The inputs may also vary based on the inputs entered for other sections (e.g. the type of interactive savings report selected) within the interactive graphics as some information entered may directly affect the calculation of other information and what characterization information is necessary later for the calculation. Additionally, a summary of calculated financial benefit values 511 according to the inputs entered by the user so far may be displayed so that a user may be aware of how each input affects the total financial savings. The summary of calculated financial benefit values 511 may be provided to a user in every section, sub-section, and screen of the interactive savings report so that the user may always know how their inputs are affecting the cost savings of the program.

The various report-specific characterization data entered by a user during the interactive savings report generation process for a purchasing card program are further described within the exemplary screenshots in FIGS. 5-10. FIGS. 5-10 show an exemplary format for the cost savings calculator application that includes five different sections of the interactive savings report with each section having different input options or sub-sections. For example, as shown in FIG. 5, the different sections are shown along the bottom of the user interface and include scenario 560, volume growth 570, source of financial benefits 580, potential financial benefits 590, and summary of the interactive savings report 595. Each section comprises different sub-sections (each sub-section is a separate interactive user interface screen for entering information). FIGS. 5-14 show each different section as well as sub-sections for the purchasing card program. The sections may stay the same for any card program implemented by the cost savings calculator so that a user may quickly and easily understand the process flow for any card program used to calculate cost savings in embodiments of the invention. However, the sub-sections may change for different programs as different information may be needed for each card program. The different sections 560-595 may be provided on the bottom of the user interface and may be visited by touching any of the buttons 560-595 to jump to that section of the interactive savings report.

The scenario section 560 provides the user questions and prompts the user enter characterization data regarding information related to the type of savings report selected. Information received in the scenario section 560 is used to calculate the financial benefits and any information that is unknown or not provided in the scenario section 560 may be filled by benchmark data received from the determined benchmark data source. Additionally, the user may be able to choose the benchmark data to use or the benchmark data source to use. The scenario section 560 corresponds to steps 213-214 of FIG. 2 and is shown in FIGS. 5-8.

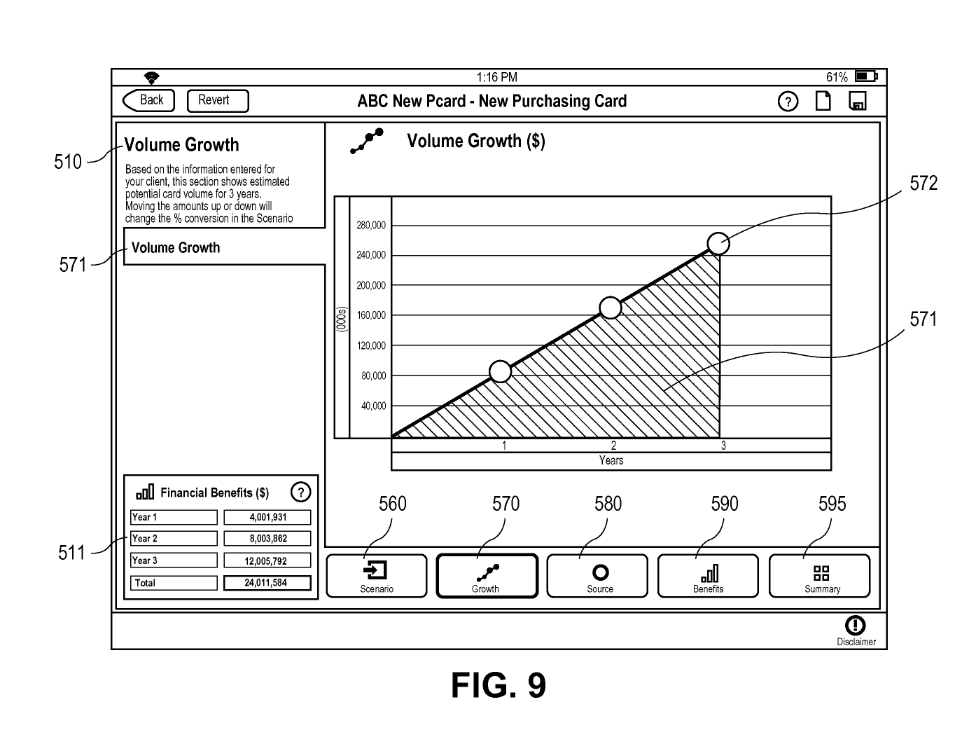

The volume growth section 570 provides an interactive screen of the interactive savings report comprising calculated financial benefit values. The volume growth section 570 provides information related to the volume of use of the purchasing card is provided. This information may be a graphical representation of information provided during the scenario section 560 including the number of invoices processed annually and the percentage of those invoices that may be converted to the purchasing card over a predetermined period of time. However, in other types of programs, the volume growth may be determined in a different manner or may relate to different summarized information related to the growth and speed of implementing the selected card program based on characterization data. The volume growth section 570 may be interactive and may allow the user to change the characterization data that impacts the financial benefit values related to the volume growth by interacting with a visual metric corresponding to the summarized data of the calculated financial benefit values. The volume growth section 570 corresponds to step 216 in FIG. 2 and is shown in FIG. 9.

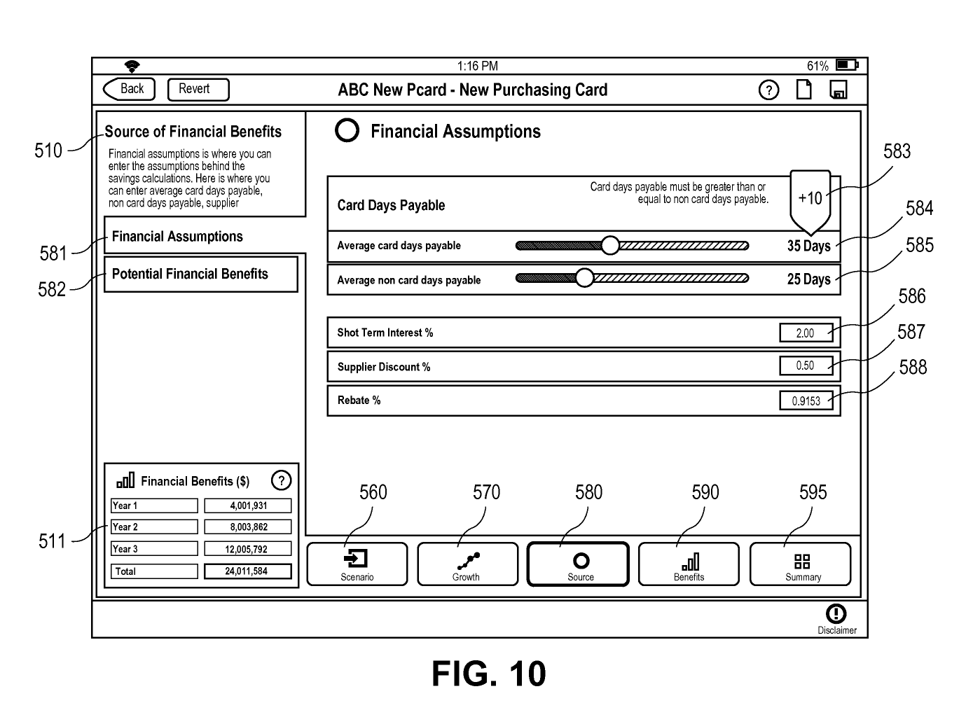

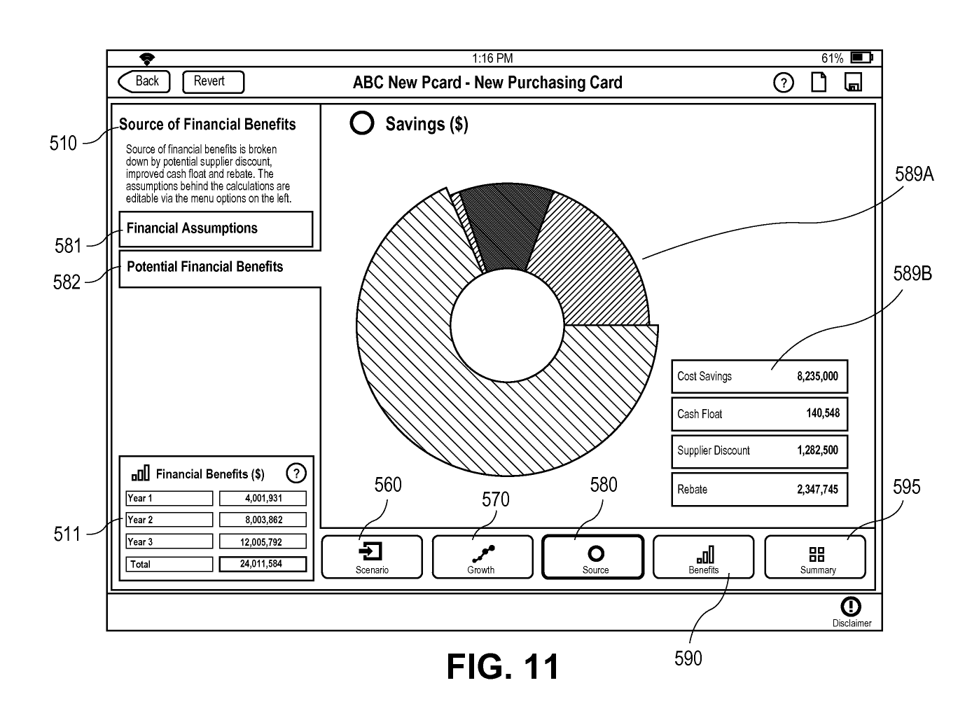

The source of financial benefits section 580 provides the characterization and benchmark data that is relied upon in the calculation of the financial benefits values. The financial benefits section 580 may be interactive and may allow the user to change the benchmark data and characterization data that is entered during the calculation process. The financial benefits section 580 comprises financial assumptions 581 and potential financial benefits sub-section 582 for a purchasing card, both of which will be described in further detail below. The source of financial benefits section 580 corresponds to step 213 and 214 in FIG. 2 and is shown in FIGS. 10-11.

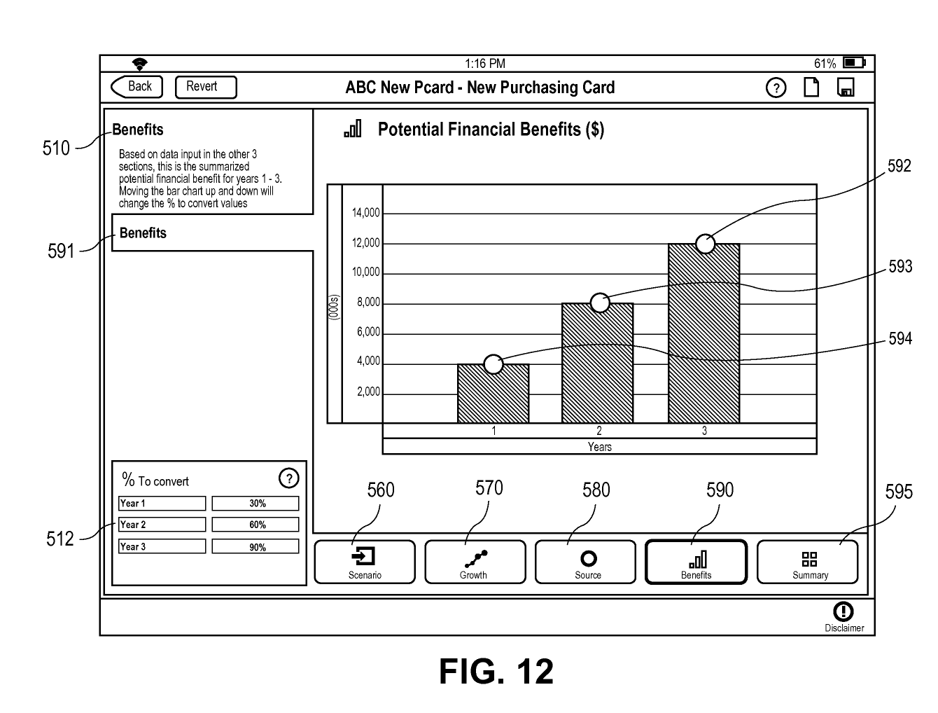

The potential financial benefits section 590 provides information regarding the total savings that the card program may save a client using the characterization and benchmark data entered in steps 211-214. The total savings may be summarized data of the calculated financial benefit values and may provide calculated savings over a predetermined time period (e.g. 3 year) or may provide a lump sum total savings summary. The potential financial benefits section 590 corresponds to step 216 in FIG. 2 and is shown in FIG. 12.

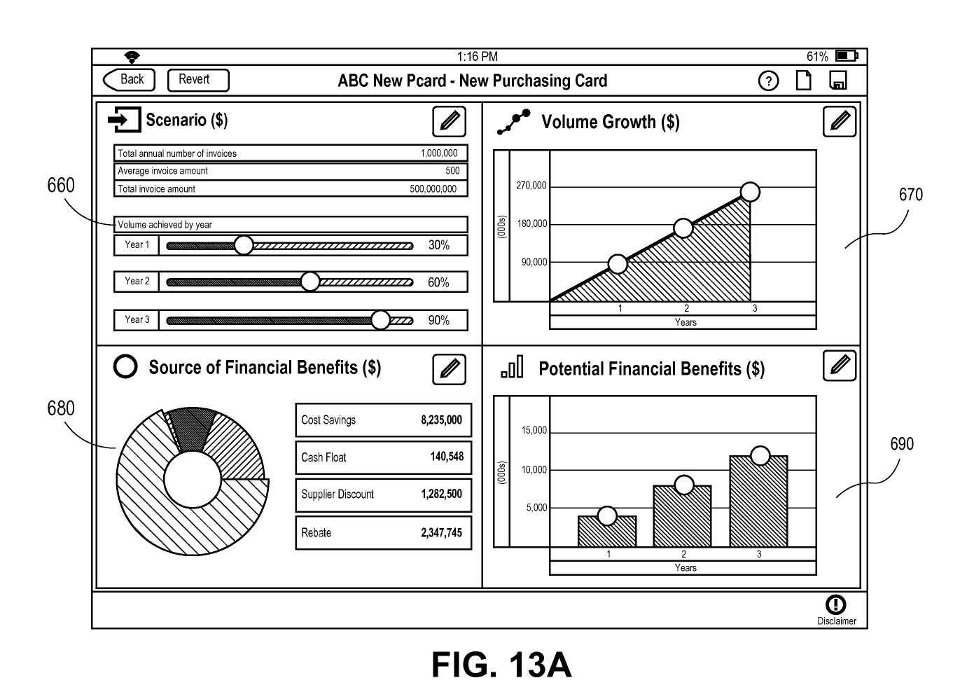

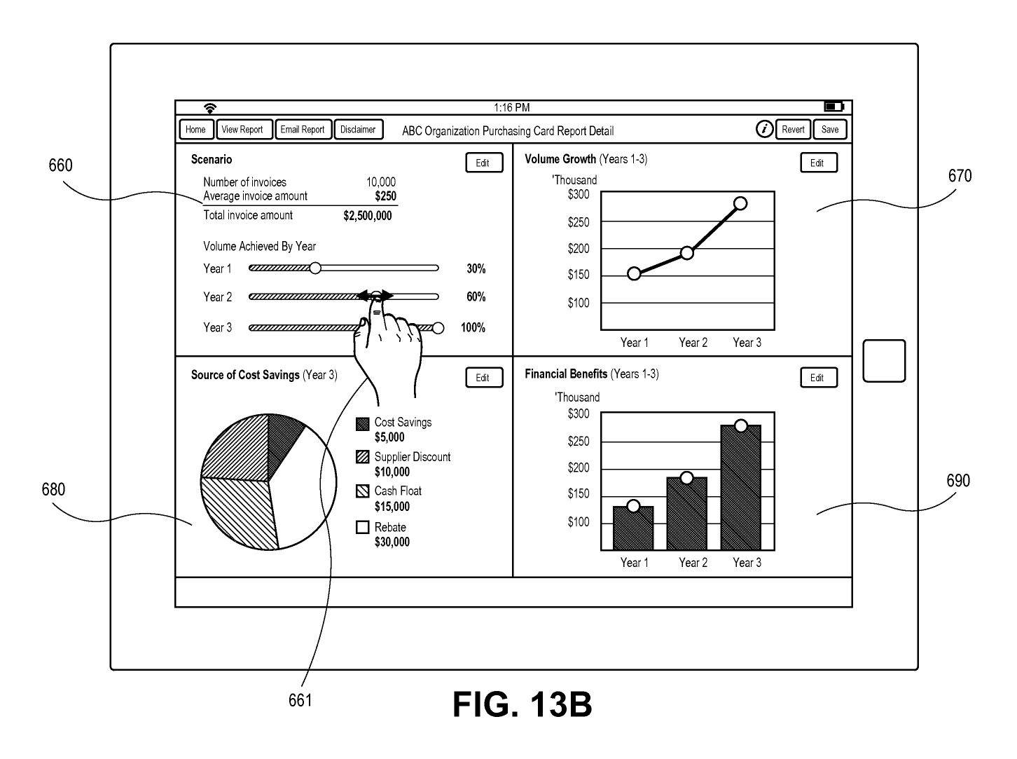

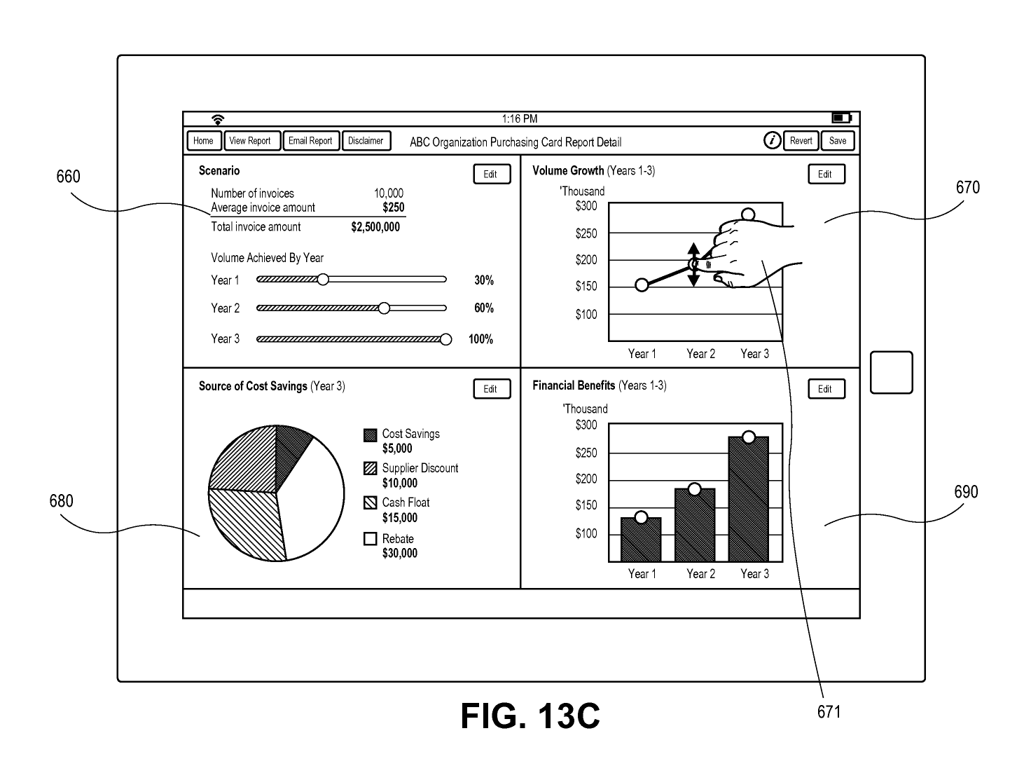

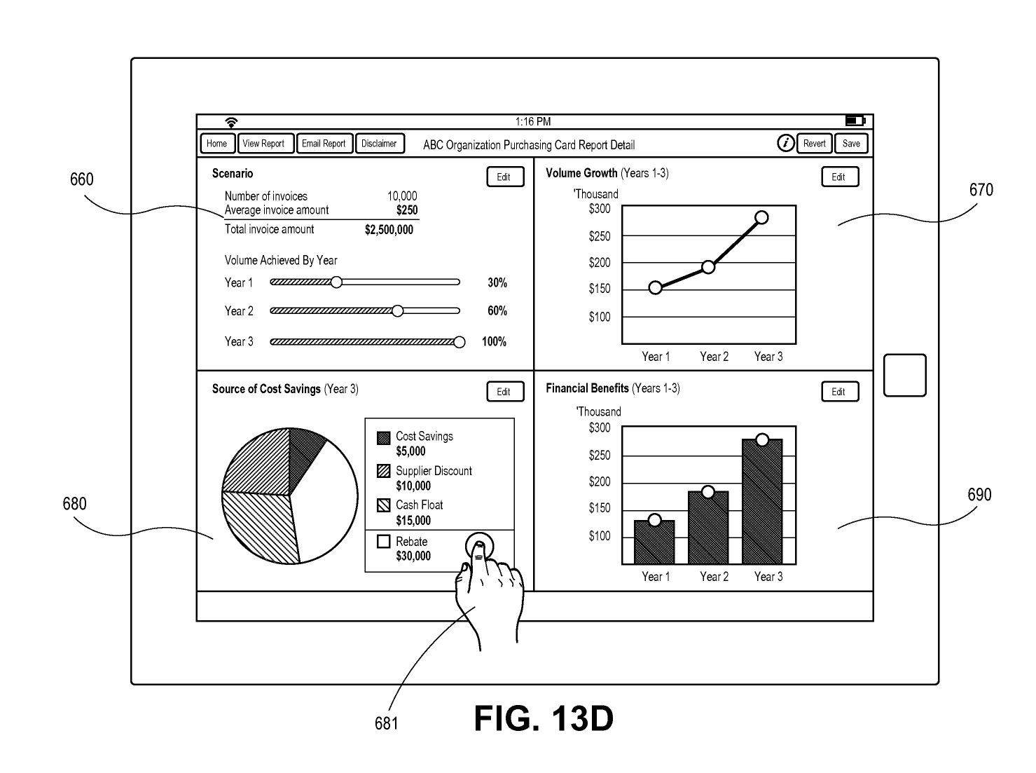

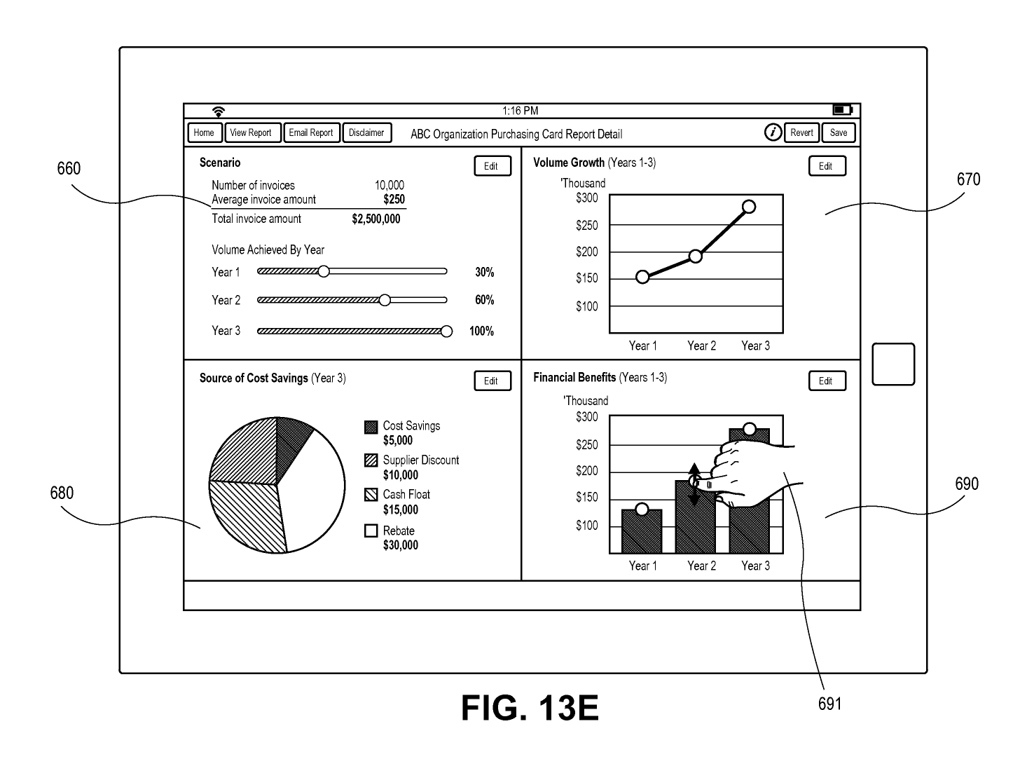

Finally, the summary of the interactive savings report section 595 provides a summary of the financial benefit values calculated from the characterization data and benchmark data entered in steps 213-214. The summary of the interactive savings report section 595 comprises a summary of the information entered or calculated for each of the other sections in the interactive savings report in four different sections (660-690) in one user interface screen. Like the other sections, the summary of the interactive savings report section 595 may be interactive and may allow a user to enter a user input to update any of the characterization data previously entered or summarized data of the financial benefits values previously calculated by the interactive savings report. The summary of the interactive savings report section 595 corresponds to step 216 in FIG. 2 and is shown in FIG. 13A.

Referring to FIG. 5, an exemplary screenshot of the scenario section 560 and the scenario sub-section 520 of the interactive graphic is shown in one embodiment. In the scenario sub-section 520, the user can view or edit the characterization information entered during initialization of the new interactive savings report (FIGS. 4A-4B), such as the organization name 521, program or interactive savings report type 522, currency 523, market sector 524, revenue 525, and employee count 526.

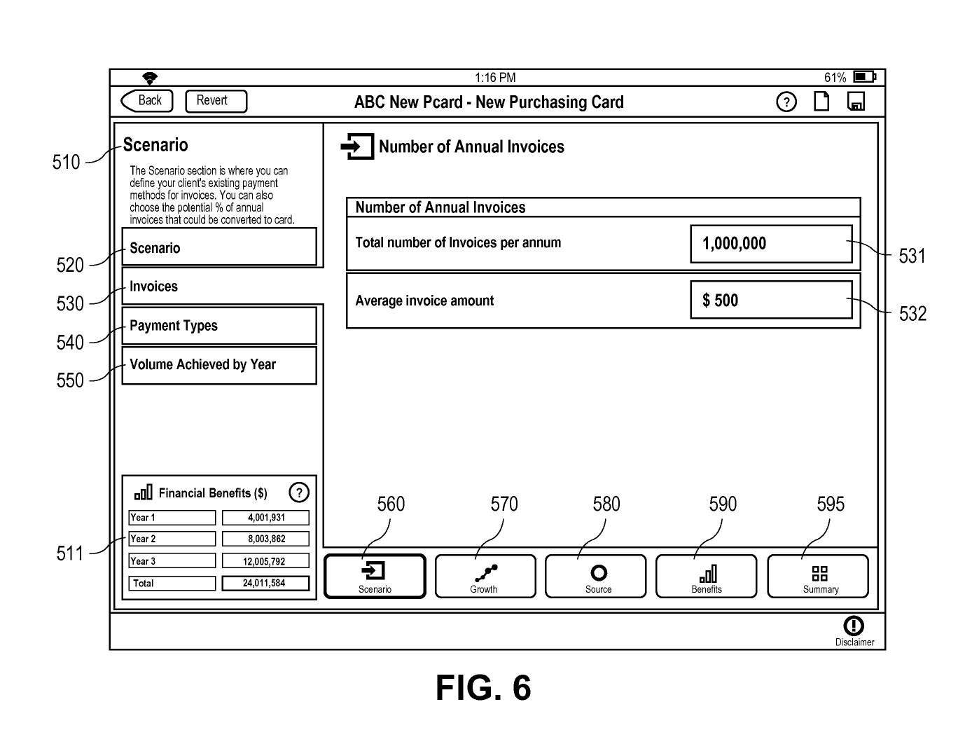

Referring to FIG. 6, an exemplary screenshot of the scenario section 560 and the invoices sub-section 530 of the interactive graphic is shown in one embodiment. In the invoices sub-section 530, the user may enter characterization data including information related to the type of savings report selected in order to further define the client's annual invoices 531 and average invoice amounts 532.

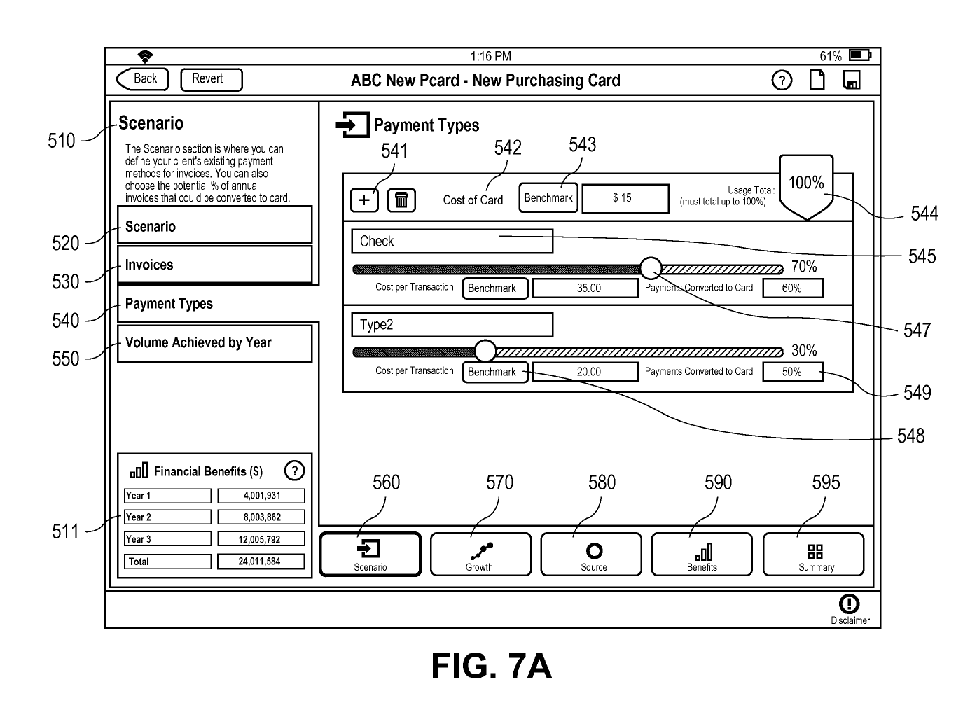

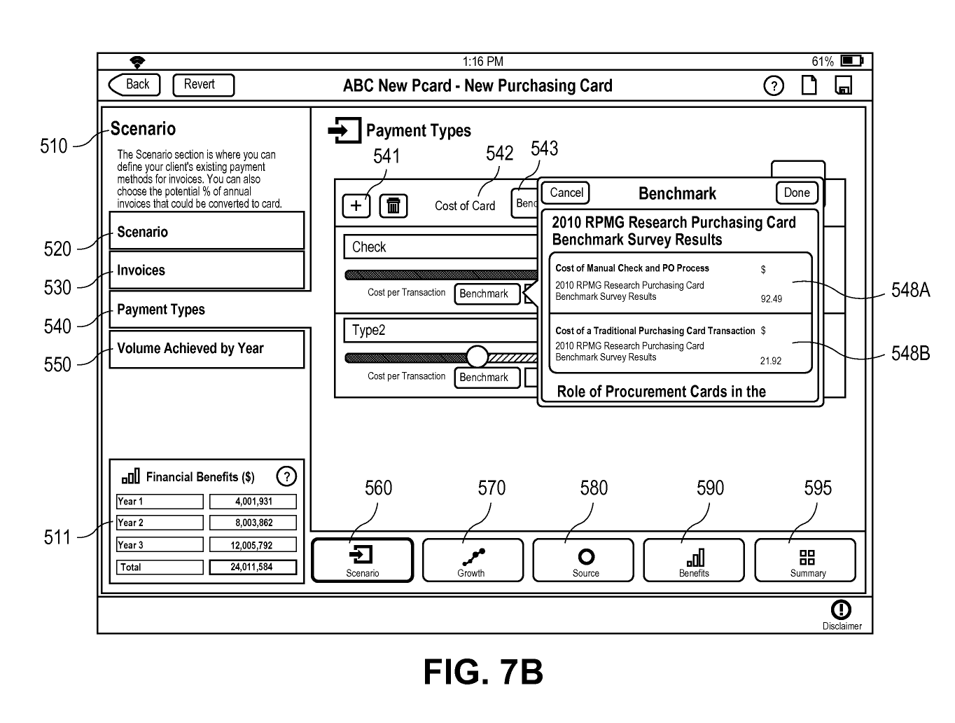

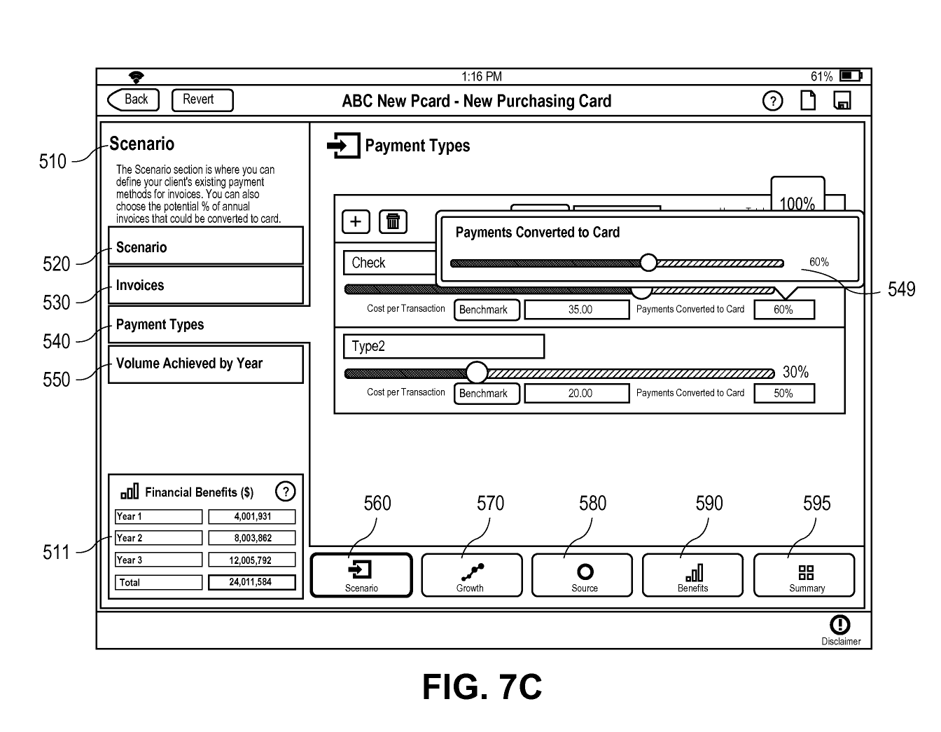

Referring to FIGS. 7A-7C, exemplary screenshots of the scenario section 560 and the payment types sub-section 540 of the interactive graphic are shown in one embodiment. In the payment types sub-section 540, various payment types 545 are defined for the client cost so that saving calculations may be performed. The payment types sub-section 545 prompts the user for characterization data related to the purchasing card interactive savings report. The payment types sub-section 540 allows the user to add or delete 541 new payment types, includes a cost of card transaction information that may be defaulted to a benchmark data source that knows the average cost of a card transaction for businesses of the type similar to the client. A benchmark button 543 may be provided such that the user may interact with the default benchmark value and may either choose a different benchmark data source or, if the user knows the average cost of a card transaction for their organization, may enter the cost of card information.

If the user adds a new payment type, the user may enter the type of payment device (e.g. check, electronic funds transfer (EFT), person-to-person payment, cash, etc.) and may enter the name or may choose the type of payment from available options. The user may enter as many different payment types as they wish. However, the user may also provide the percentage of total payments made 547 using that type of payment and all of the payment types combined should equal 100% of the payments made by the client. As such, a percentage of payment allocation identifier 544 may be provided to inform a user whether all of their payments have been allocated to different payment types.

Additionally, the cost of each type of payment type 548 may be provided. By default, the cost of each payment type 548 may be provided as benchmark data from the determined benchmark data source but as with the cost of card transactions 543 described above, the benchmark data source or the benchmark data itself may be selected or modified by the user. As shown in FIG. 7B, each payment type may have a known cost associated with it 548A, 548B such that if the user selects check from a menu of payment types, the cost of a check transaction 548A may be loaded from the previously determined benchmark data source. The costs of the type of payment types may be provided in a pop-up window regarding the details of the benchmark data for each payment type as well as for the card cost benchmark data by selecting a proximate benchmark button 543, 548. The benchmark data can provide current market statistics for the cost of various payment type transactions 548A, 548B to be processed. Additionally, the cost of the payment type 548 may be edited by the user if it is known for the client.

Finally, each payment type may have a possible percentage of payments that may be converted to card input 549. The payments converted to card 549 input provides characterization data regarding how many of the possible current payment types could be converted to the purchasing card over a predetermined time period. The payment converted to card 549 input may be a percentage, a total value or dollar amount, or could be input through any other suitable manner. Additionally, this information could be provided by a benchmark data source if the user is unsure of how many of their transactions could be converted to card. Furthermore, the user can view an exploded view of the percentages of current payments being converted to another form of payments 549, such as the percentage of check payments being converted to card payments (shown).

The user can input variable amounts on an interactive visual object to adjust the percentage of invoices that could be converted to a card payment. The adjustment of the percentage can allow a client to see potential cost savings over time in the summary of the financial benefits section 511. For example, a benchmark data source may have information related to similar companies in similar industries and the average amount of invoices they convert to card transactions within the predetermined time period. Furthermore, the payments converted to card may not include a complete conversion of all payments within a predetermined time period but may include a volume conversion growth or ramp up period.

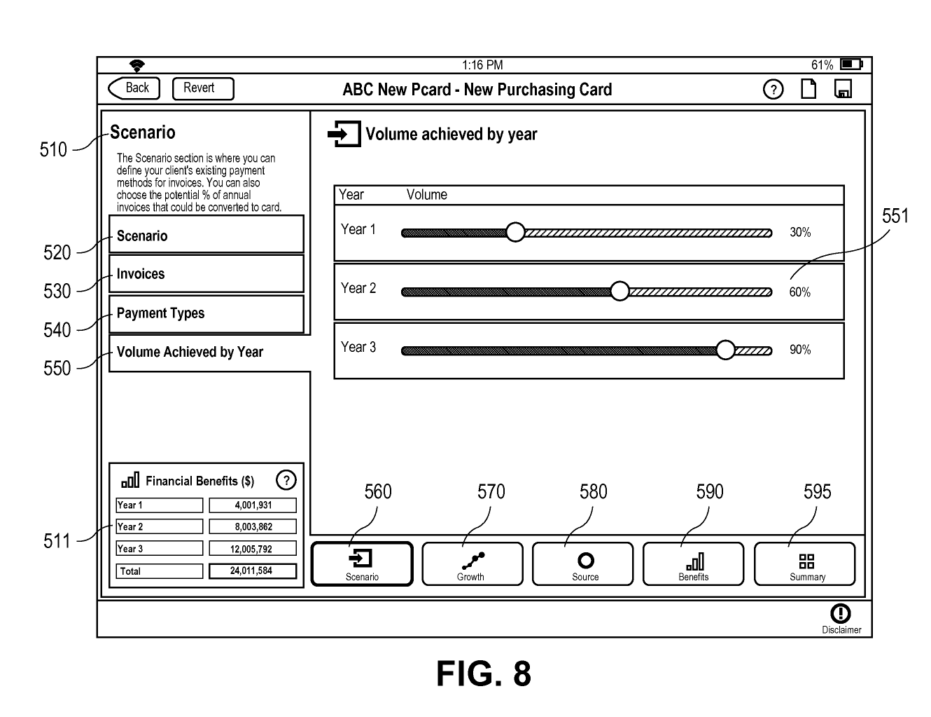

Referring now to FIG. 8, exemplary screenshots of the scenario section 560 and the volume achieved by year sub-section 550 of the interactive graphic are shown in one embodiment. In the volume achieved by year sub-section 550, characterization and benchmark data relating to the payments converted to card input 549 from the previous sub-section, is broken into smaller time periods (e.g. annual, quarterly, etc.) by which the user can enter characterization data regarding the speed with which the volume may be increased per time period (yearly in this example) 551. The characterization information related to the volume converted per year may be interactive such that the user may change the settings by interacting with visual metrics corresponding to the characterization data. For example, in FIG. 8, the user has input a conversion of 30% in the first year, 60% in the second year, and 90% in the third year. As such, the user can select a steady conversion rate over the three year period, such as 30% conversion per year (as shown). The user can also set the conversion rate through an input button on each of the three year percentages. In other embodiments, the user may wish to perform an initially higher conversion rate and then lower the conversion rate over the next two years. These are conversion rates of the total number of payment that are convertible to card that were entered in the previous interactive input. Accordingly, subsequent years may not allow a lowering of the conversion percentage as the metric is for volume growth and assumes constant progression toward complete conversion of all possible payment transactions. Like the other characterization data described above, benchmark data may be provided for the average company in their situation including the conversion rates that are typical over a set period of time for similar corporations.

Referring now to FIG. 9, an exemplary screenshot of a volume growth section 570 and the volume growth sub-section 571 of the interactive volume growth graphic are shown in one embodiment. The volume growth graph displays the client's estimated potential card volume over a period of time (e.g. three years). This graph displays the characterization data and benchmark data entered in the scenario section 560 and can be altered by adjusting the volume growth points 572 (i.e. interactive visual metrics) on the graph to update the characterization data as well as the calculated financial benefit values shown in the summary of the financial benefits section 511. As such, adjustments made to the volume growth graph 571 are directly reflected in the scenario section interactive graphic previously described.

Referring now to FIG. 10, an exemplary screenshot of a source of financial benefits section 580 and the financial assumptions sub-section 581 of the interactive savings report are shown in one embodiment. In the financial assumptions sub-section 581, a user can enter characterization data related to the financial assumptions being implemented by the cost savings calculator program. The financial assumptions implemented by embodiments of the application may vary depending on the type of interactive savings report selected by the user and in this case the financial assumptions are related to invoice transactions. The financial assumptions sub-section 581 displays an adjustable card days payable 584 and non-card days payable 585 for a card program, as well as other financial information for the client that is relevant to the cost savings calculation including current short term interest rates 586 for the client or an average client (if benchmark data is used), supplier discount rates 587, and issuer rebate rates 588.

Card days payable 584 may include the number of outstanding days before payment for an average card transaction is late. Non-card days payable 585 may be the number of outstanding days before payment for an average non-card transaction (invoice, check, cash, etc.). Card days payable will typically be longer than non-card days payable because any payment that is made is provided a thirty day or longer payables delay by the card company after the original payment is made. The longer the outstanding days payable is, the more money can be generated in short term interest gained from working capital that does not have to be paid prior to that date. As such, the more days outstanding available, the more money may be gained in interest for the extra days allowed before payment is due. Accordingly, any days outstanding that are saved by shifting payments from non-card (or invoices payable) to card days payable by the purchasing card program may be shown by an additional days payable indicator 583. The amount of financial benefit received by these extra days depends on the short term interest rate 586 the company receives. Accordingly, the short term interest rate may be provided to the cost savings calculator application by the client, if known, or the short term interest rate may be provided by a benchmark data source.

Accordingly, now all of the characterization data has been entered for the interactive savings report. Although the financial benefit values and interactive screens of the interactive savings report may be displayed throughout the method described above, only once the characterization data for all of the sections have been provided may the most accurate interactive savings report be generated.

Returning to FIG. 2, in step 208, the cost savings calculator application may receive benchmark data from the determined benchmark data source. Any characterization data that is missing, not provided by the user, or left as being provided by default benchmark data, may now be received (if not received earlier) as benchmark data from the determined benchmark data source. The benchmark data may be downloaded from the benchmark data source during the running of the calculation application to complete the information relevant to the savings calculations or may be loaded as the user completes each step or section of the interactive savings report.

Steps 209-214 of FIG. 2 provide a similar process for generating an interactive savings report as steps 203-208 but are directed to a corporate card type of interactive savings report. Although the general steps are the same as the purchasing card program, the characterization data and the information received by the cost savings calculator may be different. The differences are addressed and described in more detail below with reference to the card purchasing program section below.

In step 215, the cost savings calculator application calculates the financial benefit values from the benchmark data and characterization data. Since the calculator application has all of the characterization data from the client and has received any necessary benchmark data to complete the calculation, the potential financial benefits may now be provided for each type of saving provided by the card program.

For example, FIG. 11 shows an exemplary interface where the potential financial benefits have been calculated by the application using the characterization data provided by the client. In the figure, the potential financial benefits sub-section 582 is provided as a sub-section of the source of financial benefits section 580 but the potential financial benefits could be implemented in any suitable manner. The potential financial benefits sub-section 582 provides a summarized pie chart or other interactive graphic that shows the source of the potential cost savings as calculated by the cost savings calculator application. The potential financial benefits sub-section 582 can provide a chart 589A in which savings from each type of incentive or type of cost saving corresponding to the implemented program may be shown and their impact on the total savings may be provided. A summarized table 589B of the data in the chart can also be displayed for the user to see exact amounts of the returns from each incentive or savings type. These summarized financial benefit values provide the client insight into what impacts their bottom line and provides the most savings.

Additionally, referring now to FIG. 12, an exemplary screenshot is provided showing an exemplary potential financial benefits section 590 in which a user can view another interactive graphical display of the summarized data of the calculated financial benefit values corresponding to potential cost savings over a predetermined period of time. For example, the graph may illustrate a dollar amount for financial benefits values that a client can achieve on a yearly basis with available card programs. As with all of the other figures, the graph and other factors are interactive and as such, if a client wishes to see more or less benefits during each year, the graph can be adjusted via an input point (interactive visual metric) 592-594 for each year. Additionally, a conversion percentage summary 512 including information from the volume achieved by year sub-section 550 of the scenario section 560 may be provided where the summary of calculated financial benefit values 511 may typically be shown. The conversion percentage summary 512 of the volume achieved by year sub-section 550 may inform the user of how the adoption rate of the program may affect the total financial savings. For example, using the volume achieved by year characterization data described above, the user has input a conversion of 30% in the first year, 60% in the second year, and 90% in the third year and those rates are shown in the conversion percentage summary 512. Accordingly, the user can interact with the conversion percentages from the conversion percentage summary 512 to change the characterization data and quickly and easily see how those inputs change the potential financial benefits of the program. As previously mentioned, any adjustment to an interactive graph based on data previously entered in other sections will affect the data entries in each section and the corresponding characterization data for those entries. Each of the aforementioned sections is easily accessible through any other section by selection of the section button within the user interface. Accordingly, effects of various adjustments made in one section can be readily viewed in another section.

In step 216, the cost savings calculator application generates and displays the interactive savings report with interactive visual metrics and the interactive savings report can be displayed on a display of the mobile device for the client to view. The interactive savings report showing a summary view of the sections described above is shown in FIGS. 13A-13E. Although the calculator application may constantly generate interactive savings report information or screens that may be displayed for the user in each respective user interface, the generated and displayed interactive savings report is shown in FIGS. 13A-13E.

Referring now to FIGS. 13A-13E, an exemplary screenshot of an interactive savings report is shown. Each interactive graphical section (660-690) of the interactive savings report is provided and shown on the same screen. The summary screen of the interactive savings report may comprise visual metrics corresponding to the summarized data of the calculated financial benefit values and the visual metrics may be interactive as described previously. Accordingly, each interactive graphic on each section includes a graphical display of potential cost savings benefits over a time period (e.g. three years) for a client based on data collected through each interactive graphic section including the scenario section 660, volume growth section 670, source of financial benefits section 680, and potential financial benefits section 690.

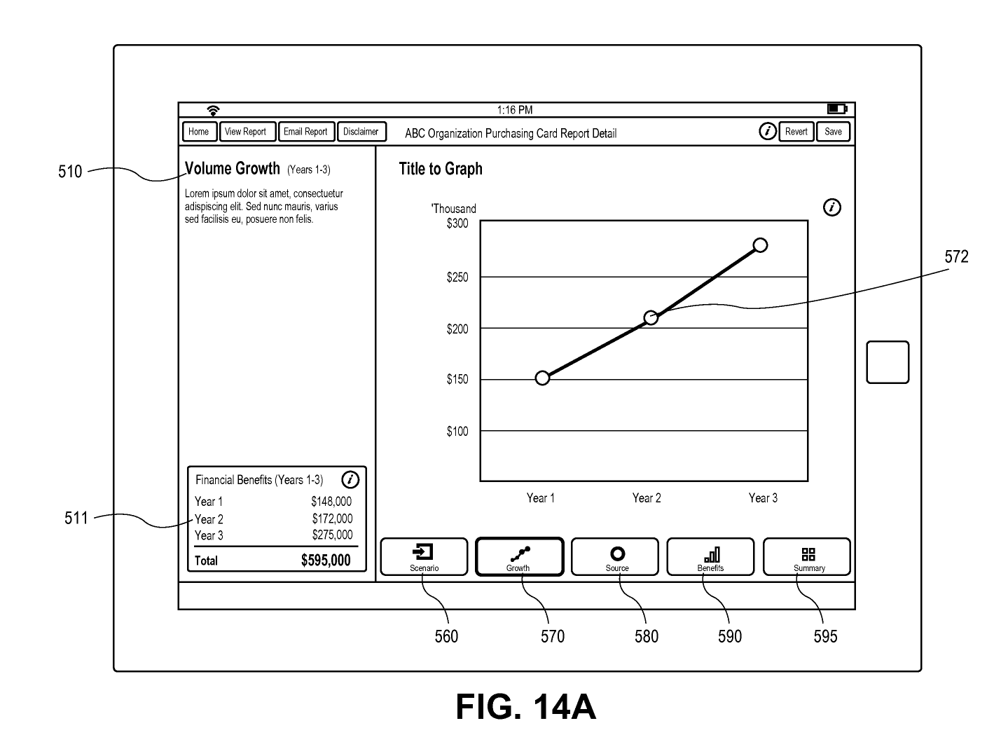

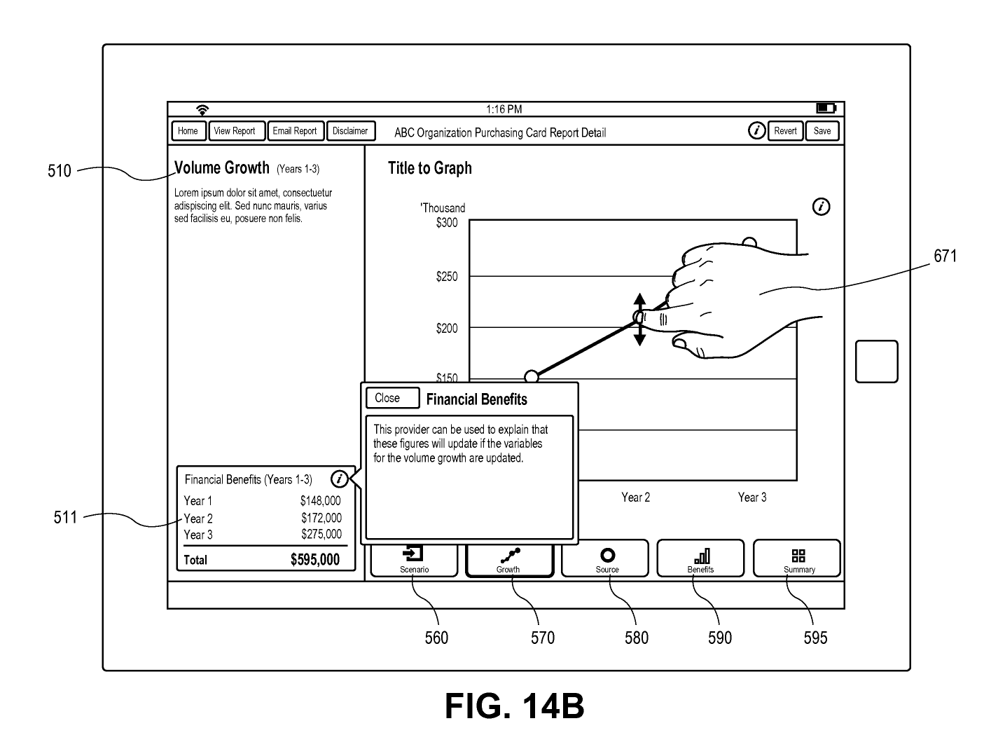

Returning now to FIG. 2, steps 217-218 of the present invention are executed by a user who interacts with the interactive savings report. In step 217, the cost savings calculator application waits to receive user input changing the interactive visual metrics of the interactive savings report. If the user provides a user input to the characterizing data or the summarized financial benefit values shown in the interactive savings report, the interactive is updated with the user input. Accordingly, the characterization data and benchmark data may be changed by the user input. As such, new financial benefit values may be calculated and updated on the display of the interactive savings report. This process may be accomplished quickly so that a user may instantly see how the user input changes the corresponding financial benefit values. This process is shown in FIGS. 13A-14B.

FIGS. 13B-13E show an example of how a user may provide user input to the plurality of visual metrics corresponding to the summarized data of the calculated financial benefit values of the interactive savings report. Accordingly, FIGS. 13B-13E illustrate how a user may interact 661 with visual metrics in the scenario section 660, how a user may interact 671 with visual metrics in the scenario section 670, how a user may interact 681 with visual metrics in the scenario section 680, and how a user may interact 691 with visual metrics in the scenario section 690. If the summary section 595 of the interactive savings report is entered previous to any financial benefits values being calculated, the summary section 595 may not display any savings data and may instead describe the various sections that are available. Accordingly, the displayed graphics do not initially display any data as the client specific data is entered upon initial generation of the report. However, the user can enter data to each section through selection of an input button located in each quadrant of each graphic.

FIGS. 14A-14B show an example of how a user may provide user input to one or more visual metrics corresponding to a section of the interactive savings report. In FIGS. 14A, an exemplary volume growth section 580 is shown based on characterization data provided by a client. FIG. 14B shows how a visual metric 572 corresponding to characterization data provided by a client may be interacted with through a user input 671 in order to update the characterization data. Accordingly, when the user interacts with the visual metric 572, the cost savings calculator application receives a user input to interact with one of the plurality of visual metrics where the interaction changes the characterization data. Accordingly, the cost savings calculator may calculate a plurality of updated financial benefit values corresponding to the updated characterization data and may update the interactive savings report (or in this case, one section of the interactive savings report). When updating the interactive savings report, the summarized data of the updated calculated financial benefit values and the plurality of visual metrics corresponding to the summarized data of the updated calculated financial benefits values are updated. Accordingly, by moving the visual metric 572 through the user input screen touch 671, the characterization data that was originally entered is changed, the financial benefits values that were calculated based on the characterization information are changed, the summarized data of the updated calculated financial benefits values 511 are changed, and all of this changed information is updated in the interactive savings report and displayed to the user and/or client. This process may continue as long as the user continues to interact with the interactive savings report through user input.

In step 219, once the user and/or client have completed their analysis of the cost savings report and the financial benefit values are ready to be distributed to other decision makers or saved for later review, the cost savings calculator application may generate a final savings report that may include the financial goals and savings information determined by the application. The final savings reports may comprise data corresponding to the sections of the interactive savings report but may also add hints, tips, and other information to the user so that they final savings report is helpful to the user long after the representative of the financial entity or issuer is present.

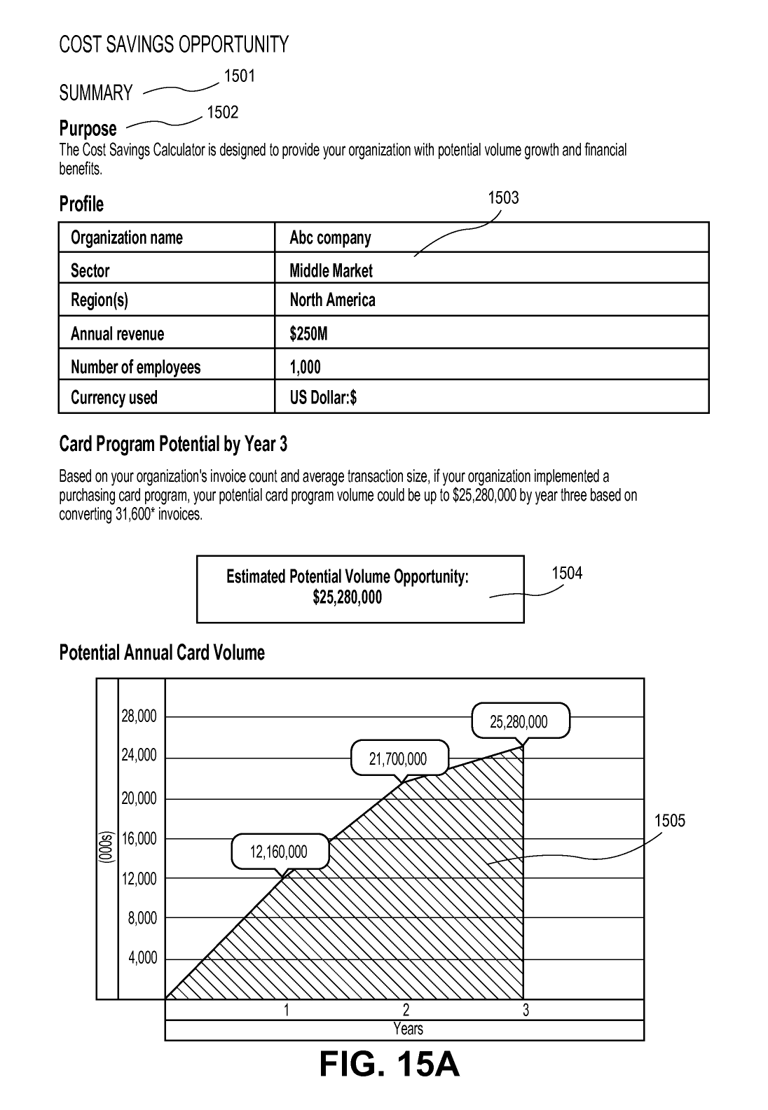

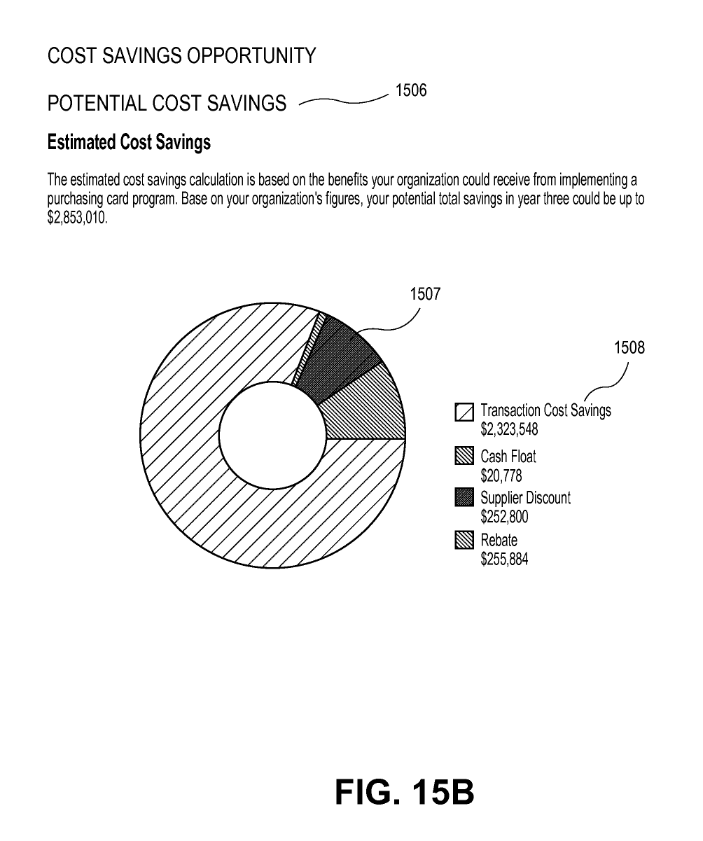

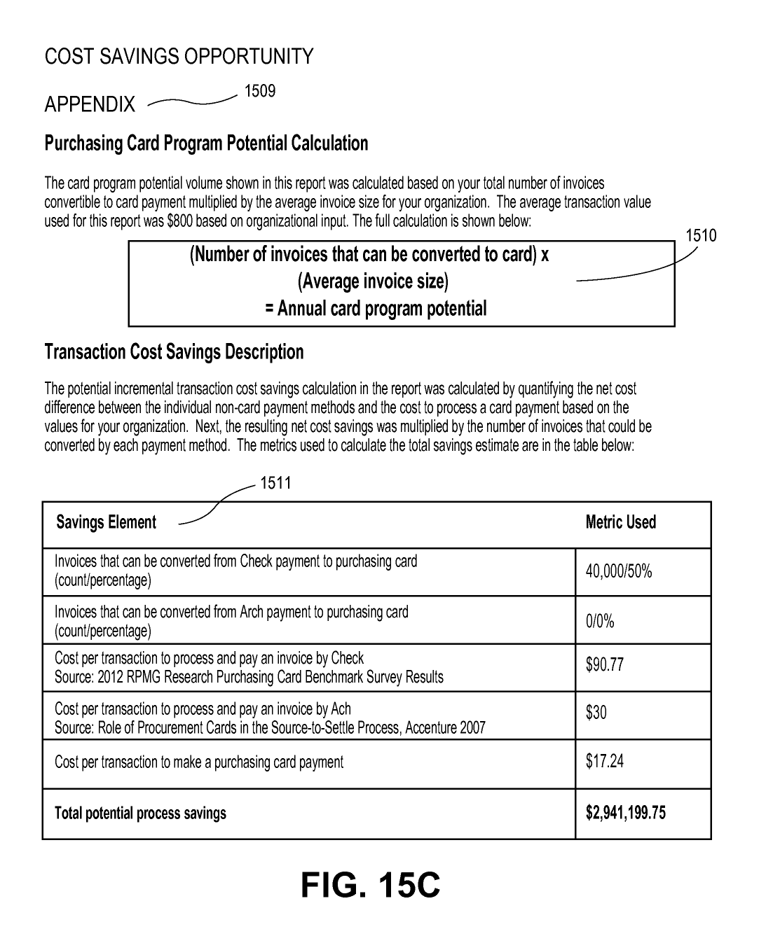

In some embodiments, the report can provide the logo of the credit card association (e.g. payment processing network), the financial entity (e.g. issuer), and the prospective client company. The report can provide a summary of the overall potential opportunity and a visual metric of that opportunity. If reviewed on the mobile device, the user can be given the option to further navigate the report and view each detail of the opportunity with the prospective client company based on several categories. Exemplary screenshots of the final savings report are shown in FIGS. 15A-15C.

As shown in FIG. 15A, an exemplary summary page 1501 of the final savings report is provided. The summary page 1501 can state the purpose 1502 of the report as well as the entity profile information (i.e. entity information) 1503 as inputted into the cost savings calculator application previously. The summary 1501 can additionally provide an estimate of the card program potential 1504 corresponding to the source of financial benefits section 580 of the interactive savings report. The summary 1501 can additionally show a graph of the potential annual card volume 1505 that can be converted by the client, corresponding to the volume growth section 570 of the interactive savings report.

FIG. 15B illustrates an exemplary potential cost savings section 1506 including estimated cost savings graphics 1508 corresponding to an interactive report generated by the cost savings application based on the characterization data provided by the client. The potential savings estimate 1508 may correspond to the potential financial benefits section 590 of the interactive savings report. The estimates may include information over a number of years (not shown) and may include a total amount 1508. The cost savings opportunity section 1506 may also include an estimated incremental cost savings section 1508 that displays the potential process cost savings, source (e.g. supplier) discounts, and potential cash/card float which may correspond to the source of benefits 580 section of the interactive savings report. A graphic 1507 (e.g. a pie chart) showing information from the source of the financial benefits section 580 of the interactive savings report may also be provided.

FIG. 15C illustrates an exemplary potential cost savings opportunity appendix section 1509 of a final savings report generated by the cost savings application based on the characterization data provided by the client. The appendix 1509 may include a card program potential calculation section 1510 which describes how the cost savings were calculated. Furthermore, the appendix may comprise a best practices section (not shown) which displays tips and tricks regarding what actions may be used to fulfill the program potential. The estimated cost savings may also include a table 1511 of the characterization data and benchmark data used to help the user evaluate the purchasing card program potential.

The user can then be given several options to provide the report to a client, such as saving, sending (e.g., via email), printing, etc. For example, the user can select to generate a portable document format (.pdf) of the report, to email the final savings report to a recipient (e.g. the client company), to store the report in the reports archive, or to view a report in the archive (e.g. compare reports). If a PDF of the report is generated and/or the final report is compiled and emailed to a client company, the report can provide each of the aforementioned analytical data in summarized form. Additionally, the report can include any number of visual metrics, such as bar graphs, pie charts, graphs, grids, bar charts, tables, etc., each displaying a different cost saving aspect of the program for the company based on past data, (e.g. past annual revenues, projected revenues, etc.), based on market and company performance over a set amount of time. These visual metrics can also include summaries of the client company's current usage of a card (e.g. transactions, potential transactions, current payment methods, etc.). However, the visual metrics provided in the final savings report may not be interactive as in the interactive savings report.

### III. Exemplary Methods for Corporate Card Programs

As explained previously, steps 209-214 of FIG. 2 are similar to those described above but relate to a selected type of payment device corresponding to a corporate card. Accordingly, steps 209-214 are addressed below. Additionally, any other possible card program could also be implemented using similar steps to those described in reference to the purchasing card and corporate card but different characterization data may be provided by the client and different benchmarks may be implemented.

For example, in step 213, instead of receiving “invoice information” related to a purchasing card program, embodiments of the present invention implementing corporate card programs may receive spending information. Otherwise the main steps of embodiments are the same, although the questions, characterization data, and benchmark data provided to the cost savings calculator may change depending on the type of interactive savings report selected. For example, questions may focus on expenses related to air travel, lodging, auto rental, restaurants, other travel expenses, and entertainment, instead of invoice costs. In this type of interactive savings report the current expenditures of the company can be compared to the target expenditures which would allow the company to maximize card benefits and return based on the card program determined in the cost savings calculator application report. Accordingly, in the corporate card (e.g. corporate travel card) embodiment of the application, different input options are provided including annual travel spending, spend categories, current spending, targeted card spending, and volume of spending achieved by year. For instance, the scenario section may define annual spending attributes for the corporate card account including the total annual travel spending and the annual travel spending on the card.

Additionally, the cost savings calculator may prompt the user and/or client for characterization information related to the spending category attributes for the corporation. In this section, the user may input the percentage of their total spending that can be attributed to particular categories including air travel, lodging, auto rental, restaurants, entertainment, and other or miscellaneous expenses.

Another section may define current expenditures for the corporate card account. In this section, the user inputs how much of the total spending is attributed to their current card account purchases. The total may equal the annual travel spending on the card from the previous section.

Additionally, another section may be directed to a target or goal of the total annual travel spending that they would like to use their corporate travel card account in order to purchase in the future. The user may also be prompted for volume achieved by year input instead of invoice payments converted per year which allows realistic gains in the use of the card volume as compared to the targeted card spending. For example, the volume achieved per year may have an input of 10% volume growth of the corporate travel card account usage per year. Accordingly, the total current card spending may be increased by the volume achieved by year input and may determine the volume growth of the corporate travel card account spending at those rates. As such, users may be able to see how much the spending inputs directly impact their usage of the corporate travel card over time, just as they do with the purchasing card program described and shown in the exemplary figures.

Another section may be directed to expense report automation where calculations are implemented for the corporate card account. These settings may be defined by expense information input by the client or may be edited by the user to further change the scenario and the potential savings. Additionally, savings related to expense report automation may be provided that ask clients to input characterization data for the amount of savings per report and the number of reports that may be automated. A total savings is determined based off of these settings.

Savings may also be provided by cash advance elimination for the corporate card account. Cash advances information may provide the total cash advances currently being used, the percentage of advances planned on being converted, the savings per cash advance, and the savings resulting by converting the cash advances. The user may interact and edit the settings to determine the most realistic scenario and/or the scenario with the most possible savings.

Finally, savings may be provided by sourcing and issuer rebate discounts by using the corporate travel card account and the user may be able to edit the amount of savings they receive to determine the most realistic scenario. The total savings for each category is also provided based on the percentage discount. The rebate may be provided by an issuing financial institution that wants to incentivize use of their card and a rebate percentage may be editable by the user to determine the most realistic numbers based on any consumer situation.

### IV. Technical Advantages

Embodiments of the present invention provide multiple technical advantages. For example, the analytical tool helps issuers demonstrate the value in cost savings of starting or optimizing a card program. The user friendly interface allows a user to vary assumptions to see new results immediately, provide implementation goals, institutional controls, and see the financial benefits of such changes. The cost savings calculator program may help sales professionals representing financial entities demonstrate the potential volume and savings of a new commercial card program, change key assumptions dynamically during the sales call in order to implement multiple scenarios, answer customer questions, or provide graphical representations of hypothetical situations. The application further allows sales professionals to email the results immediately to the prospective client company representative. Additionally, the calculator may calculate how much growth could be realized from the card program, show potential increase in transaction costs savings, improvement in working capital, increased rebate, and benefits from automation or other card programs. Additionally, the calculator program may keep track of implementation levels and track the progress of the program according to current implementation.

### V. Additional Exemplary Embodiments

Provided below is a description of an exemplary system in which embodiments provided herein may be utilized. Although some of the entities and components may be depicted as separate, in some instances, one or more of the components may be combined into a single device or location (and vice versa). Similarly, although certain functionality may be described as being performed by a single entity or component within the system, the functionality may in some instances be performed by multiple components and/or entities (and vice versa). Communication between entities and components may comprise the exchange of data or information using electronic messages and any suitable electronic communication medium and method, as described below.

As used herein, an “issuer” may typically refer to a business entity (e.g., a bank or other financial institution) that maintains financial accounts for the user 30 and often issues a payment device 32 such as a credit or debit card to the user 30. As used herein, a “merchant” may typically refer to an entity that engages in transactions and can sell goods or services to the user 30. As used herein, an “acquirer” may typically refer to a business entity (e.g., a commercial bank or financial institution) that has a business relationship with a particular merchant or similar entity. Some entities can perform both issuer and acquirer functions.

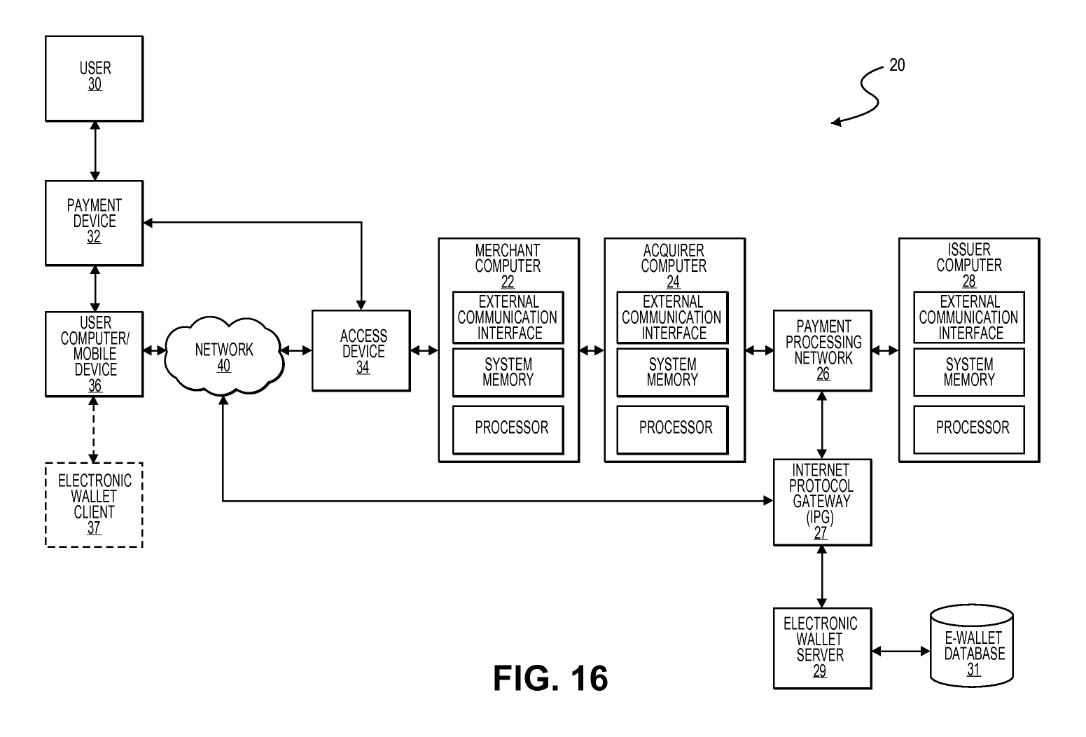

An exemplary financial transaction system is shown in FIG. 16. The transaction system may be used to process payments or preform transactions that are included in the card programs described in embodiments of the present invention. FIG. 16 shows the interaction of the different entities within the system 20. The system 20 may include one or more merchants, one or more access devices 34, one or more payment devices 32, one or more acquirers, and one or more issuers. For example, the system 20 may include a merchant having a merchant computer 22 that comprises an external communication interface (e.g. for communicating with an access device 34 and an acquirer 24), system memory comprising one or modules to generate and utilize electronic messages, and a data processor (for facilitating a financial transaction and the exchange of electronic messages); an acquirer having an acquirer computer 24 that comprises an external communication interface (e.g. for communicating with a merchant computer 22 and a payment processing network 26), system memory comprising one or modules to generate and utilize electronic messages, and a data processor (for facilitating a financial transaction and the exchange of electronic messages); and an issuer having an issuer computer 28 that comprises an external communication interface (e.g. for communicating with a payment processing network 26), system memory comprising one or modules to generate and utilize electronic messages, and a data processor (for facilitating a financial transaction and the exchange of electronic messages). The external communication interface of the merchant computer 22 may be coupled to an access device 34 (such that information may be received by the access device 34 and communicated to the merchant computer 22) or, in some embodiments, the access device 34 may comprise a component of the merchant computer 22.

As used in this context, an “external communication interface” may refer to any hardware and/or software that enables data to be transferred between two or components of system 20 (e.g., between devices residing at locations such as an issuer, acquirer, merchant, payment processing network 26, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components in the system 20 may be used. Some examples of such methods may include utilizing predefined and static fields (such as in core TCP/IP protocols); “Field: Value” pairs (e.g. HTTP, FTP, SMTP, POP3, and SIP); an XML based format; and/or Tag-Length-Value format.

As shown in the exemplary system 20 in FIG. 16, information from the payment device 32 may be provided to access device 34 either directly (e.g. through a contact or contactless interface) or indirectly thorough a user computer or mobile device 36 (e.g. in an e-commerce environment or other indirect transaction) via network 40 (such as the Internet). In some embodiments, the user computer or mobile device 36 may interact with the payment processing network 26 (or other entity in the system 20) via the network 40 to form a first communications channel, such as through an Internet Protocol Gateway (IPG) 27. The IPG 27 may be in operative communication with the payment processing network 26. Although the IPG 27 is shown as being a separate entity in FIG. 16, the IPG 27 could be incorporated into the payment processing network 26, or could be omitted from the system 20. In the latter situation, the first communications channel could directly connect the payment processing network 26 and the user computer or mobile device 36. In general, providing communication from the user 30 to the payment processing network or other entity may enable a variety of increased functionalities to the user 30, such as advanced authentication and verification methods (particularly in e-commerce and similar transactions), examples of which are described in U.S. Ser. No. 12/712,148 filed on Jul. 16, 2010 and U.S. Ser. No. 13/184,080 filed on Jul. 15, 2011, each of which is incorporated by reference herein in its entirety. However, embodiments are not so limited.

In some embodiments, an electronic or digital wallet (i.e. “e-Wallet”) may be utilized as a payment device for conducting a financial transaction. As shown in FIG. 16, such exemplary systems may comprise an electronic wallet server 29, which may be accessible to the user 30 via network 40 (either directly connected or through an IPG 27) and may also be in operational communication a merchant and/or with a payment processing network 26 (or in some embodiments, the electronic wallet server 29 may comprise a part of the payment processing network 26). The electronic wallet server 29 may be programmed or configured to provide some or all of the functionality associated with conducting transactions using an electronic wallet, including maintaining an association between the user's e-wallet and one or more payment accounts (such as a bank account or credit card account) in E-Wallet database 31. To provide electronic wallet services (i.e. the use of the electronic wallet associated with a payment account to conduct a financial transaction), the electronic wallet server 29 may further provide a web interface (e.g. through one or more web pages) to receive and transmit requests for payments services and/or may provide an application program interface (API) (shown as electronic wallet client 37) at the user computer apparatus 36 to provide the web service. This process is described in more detail in U.S. Ser. No. 61/466,409 filed on Mar. 22, 2011, which is incorporated herein by reference in its entirety.

As noted above, the user's electronic wallet may be stored in the E-Wallet database 31, which may include information associated with the user's payment accounts can be used in conducting a financial transaction with a merchant. For example, the E-Wallet database 31 may include the primary account numbers of one or more payment accounts (e.g., payment accounts associated with a credit card, debit card, etc) of the user 30. The e-wallet may be populated with such information during an initial enrollment process in which the user 30 enters information regarding one or more of the payment accounts that may be associated with various issuers. Once the payment account information is added to the E-Wallet database 31, the user 30 may perform transactions by utilizing only his e-wallet. When a user 30 performs a transaction using his electronic wallet, the user 30 need not provide the merchant with payment account information, but may instead provide the electronic wallet information. This information may then be included in an authorization request message, which in turn may be provided to payment processing network 26. The payment processing network 26 may then access the user's e-wallet via a request to the electronic wallet server 29, or may have direct access to the e-wallet database 31 so as to obtain the corresponding payment account information indicated by the information in the authorization request message.

The electronic wallet client 37 may comprises any suitable software that provides front end functionality of the electronic wallet to the user 30. For example, the electronic wallet client 37 may be embodied as a software application downloadable by a computer apparatus or mobile device 32 (e.g., a mobile phone). In some instances, the electronic wallet client 37 may provide a user interface (such as a series of menus or other elements) that allows the user 30 to manage his electronic wallet(s) (i.e. the electronic wallet client 37 may enable interaction with the electronic wallet server 29, and thereby the e-wallet database 31). In some embodiments, the electronic wallet client 37 may store data in a computer readable memory for later use, such as user 30 preferences or identifiers associated with funding sources added to the electronic wallet.

A payment processing network 26 may be disposed between the acquirer computer 24 and the issuer computer 28 in the system 20. Furthermore, the merchant computer 22, the acquirer computer 24, the payment processing network 26, and the issuer computer 28 may all be in operative communication with each other (i.e. although not depicted in FIG. 16, one or more communication channels may exist between each of the entities, whether or not these channels are used in conducting a financial transaction).

The payment processing network 26 may include data processing subsystems, networks, and operations used to support and deliver authorization services, exception file services, and clearing and settlement services. For example, the payment processing network 26 may comprise a server computer, coupled to a network interface (e.g. by an external communication interface), and a database(s) of information. An exemplary payment processing network may include VisaNet™, CYBERSOURCE, AUTHORIZE.NET, PLAYSPAN, etc. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 26 may use any suitable wired or wireless network, including the Internet.

Although many of the data processing functions and features of some embodiments may be present in the payment processing network 26 (and a server computer therein), it should be understood that such functions and features could be present in other components such as the issuer computer 28, and need not be present in the payment processing network 26, or a server computer therein.

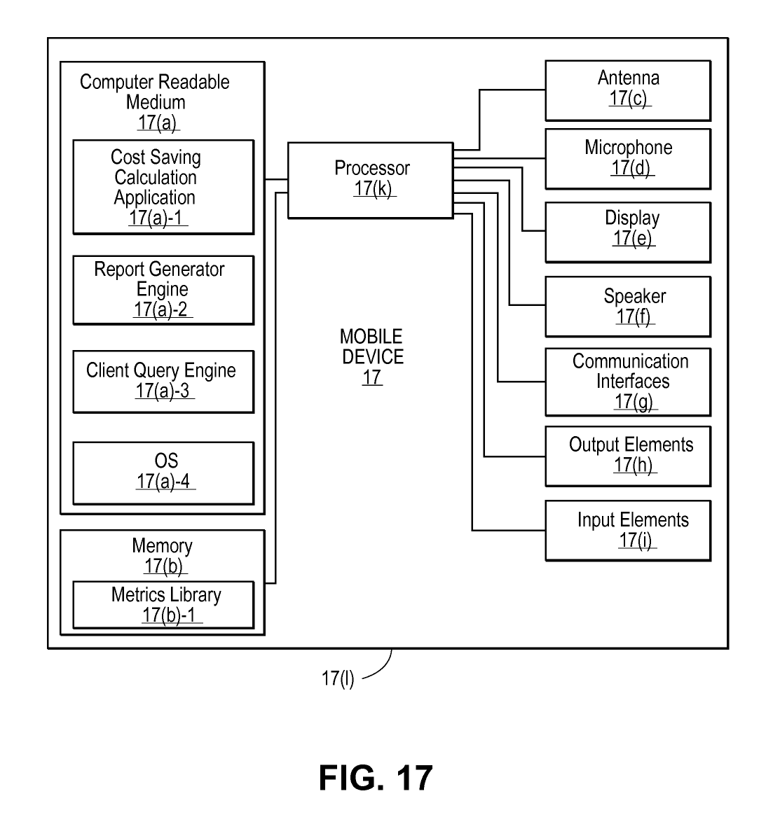

Referring now to FIG. 17, an exemplary mobile device which may be utilized to run the cost savings calculator is illustrated. FIG. 17 is a functional block diagram of a mobile device 17 according to an embodiment of the present invention. As shown in FIG. 1, the mobile device 17 may be in the form of cellular phone or smartphone, having a display 17(e) and input elements 17(i) to allow a user to input information into the device 17 (e.g., keyboard, touchscreen/digitizer, input buttons), memory 17(b). The mobile device 17 can also include a processor 17(k) (e.g., a microprocessor) for processing the functions of the mobile device 17, at least one antenna 17(c) for wireless data transfer, a microphone 17(d) to allow the user to transmit his/her voice through the mobile device 17, and speaker 17(f) to allow the user to hear voice communication, music, etc. In addition, the mobile device 17 may include one or more interfaces in addition to antenna 17(c), e.g., a wireless interface coupled to an antenna. The communications interfaces 17(g) can provide a near field communication interface (e.g., contactless interface, Bluetooth, optical interface, etc.) and/or wireless communications interfaces capable of communicating through a cellular network, such as GSM, or through Wi-Fi, such as with a wireless local area network (WLAN). Accordingly, the mobile device 17 may be capable of transmitting and receiving information wirelessly through both short range, radio frequency (RF) and cellular and Wi-Fi connections. Additionally, the mobile device 17 can be capable of communicating with a global positioning system (GPS) in order to determine to location of the mobile device. In the embodiment shown in FIG. 1, antenna 17(c) may comprise a cellular antenna (e.g., for sending and receiving cellular voice and data communication, such as through a network such as a 3G or 4G network), and interfaces 17(g) may comprise one or more local communication. In other embodiments contemplated herein, communication with the mobile device 50 may be conducted with a single antenna configured for multiple purposes (e.g., cellular, transactions, etc.), or with further interfaces (e.g., 3, 4, or more separate interfaces).

The mobile device 17 can also include a computer readable medium 17(a) coupled to the processor 17(k), which stores application programs and other computer code instructions for operating the device, such as an operating system (OS) 17(a)−4. In an embodiment of the present invention, the computer readable medium 17(a) can include a cost saving calculator application 17(a)−1. The cost saving calculator application can automatically run each time that a user accesses the application. The application can be used to display and input the various input stages of the cost saving calculator application along with the user profile.

Referring again to FIG. 17, the computer readable medium 17(a) can also include a report generating engine 17(a)−2. The report generating engine 17(a)−2 can input all the data and selected options entered by the user and perform functions on the data. The functions can be stored within the application instructions and called in order to generate a report for a client.

The computer readable medium 17(a) on the mobile device 17 can also include a client query engine 17(a)−3, which generates the questions for the client based on the option selected during the initial report generation stages and based on the answers provided to previous questions asked to the client. Additionally, the client query engine 17(a)−3 can be utilized to generate the report specific input options as described in reference to the method of FIG. 1 above.

The mobile device 17 can additionally include metrics library 17(b)−1, capable of providing visual metrics of the data generated in the report. In such embodiments, the mobile device 17 may include a non-transitory computer readable storage medium, e.g., memory 17(b), for storing generated reports, the metric library 17(b)−1, a language library (not shown) and any additional application specific data which can be locally stored on the mobile device when the application is downloaded.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method comprising:
receiving, at a computing device, characterization data associated with an entity;
determining a benchmark data source corresponding to the characterization data;
receiving benchmark data from the determined benchmark data source;
calculating financial benefit values from the benchmark data and characterization data; and
generating an interactive savings report, wherein the interactive savings report includes summarized data of the calculated financial benefit values; and
displaying the interactive savings report including a plurality of visual metrics corresponding to the summarized data of the calculated financial benefit values, wherein the plurality of visual metrics are interactive.

2. The method of claim 1 further comprising:
receiving a user input to interact with one of the plurality of visual metrics, wherein the user input changes the characterization data;
calculating a plurality of updated financial benefit values corresponding to the updated characterization data;
updating the interactive savings report, wherein the interactive savings report includes summarized data of the updated calculated financial benefit values; and
updating the plurality of visual metrics corresponding to the summarized data of the updated calculated financial benefit values.

3. The method of claim 1 further comprising:
generating an email comprising the interactive savings report; and
sending the email to a representative associated with the entity.

4. The method of claim 1 further comprising before receiving the characterization data, receiving a selection of a type of savings report based on a type of payment device.

5. The method of claim 4 wherein characterizing data comprises entity information and information related to the type of savings report selected.

6. The method of claim 5 wherein the entity information comprises geographic area, preferred currency, annual revenue, employee count, and sector of the entity.

7. The method of claim 5 wherein the type of savings report selected comprises one of a purchasing card program, a corporate card program, and a payables automation program.

8. The method of claim 7 wherein information related to the type of savings report selected when the type of savings report selected is the purchasing card program or the payables automation program comprises a total number of invoices processed annually, an average size of invoice, a current purchasing program volume, current payment methods and volume for each of the payment methods, a percentage for each of the payment methods that could be converted to the purchasing card program or payables automation, an average card days payable, an average non-card days payable, a short term interest rate, a supplier discount, and an issuer rebate.

9. The method of claim 7 wherein information related to the type of savings report selected when the type of savings report selected is the corporate card program comprises a total annual spending on travel, current corporate card program spending, a percentage of travel budget being spent on airfare, lodging, auto rental, restaurant, entertainment, and miscellaneous sources, conversion targets for predetermined time periods, a number of total manual expense reports processed annually, a percentage of manual expense reports that could be automated, total number of cash advances processed annually, a percent of cash advances that could be eliminated, a supplier discount, and an issuer rebate.

10. The method of claim 1 wherein the computing device is a mobile device.

11. A computing device comprising:
a processor;
a computer readable medium coupled to the processor and comprising code executable by the processor to implement a method, the method comprising:
receiving characterization data associated with an entity;
determining a benchmark data source corresponding to the characterization data;
receiving benchmark data from the determined benchmark data source;
calculating financial benefit values from the benchmark data and characterization data; and
generating an interactive savings report, wherein the interactive savings report includes summarized data of the calculated financial benefit values; and
displaying the interactive savings report including a plurality of visual metrics corresponding to the summarized data of the calculated financial benefit values, wherein the plurality of visual metrics are interactive.

12. The computing device of claim 11 wherein the method further comprises:
receiving a user input to interact with one of the plurality of visual metrics, wherein the user input changes the characterization data;
calculating a plurality of updated financial benefit values corresponding to the updated characterization data;
updating the interactive savings report, wherein the interactive savings report includes summarized data of the updated calculated financial benefit values; and
updating the plurality of visual metrics corresponding to the summarized data of the updated calculated financial benefit values.

13. The computing device of claim 11 wherein the method further comprises:
generating an email comprising the interactive savings report; and
sending the email to a representative associated with the entity.

14. The computing device of claim 11 wherein the method further comprising before receiving the characterization data, receiving a selection of a type of savings report based on a type of payment device.

15. The computing device of claim 14 wherein the characterizing data comprises entity information and information related to the type of savings report selected.

16. The computing device of claim 15 wherein the entity information comprises geographic area, preferred currency, annual revenue, employee count, and sector of the entity.

17. The computing device of claim 15 wherein the type of savings report selected comprises one of a purchasing card program, a corporate card program, and a payables automation program.

18. The computing device of claim 17 wherein information related to the type of savings report selected when the type of savings report selected is the purchasing card program or the payables automation program comprises a total number of invoices processed annually, an average size of invoice, a current purchasing program volume, current payment methods and volume for each of the payment methods, a percentage for each of the payment methods that could be converted to the purchasing card program or payables automation, an average card days payable, an average non-card days payable, a short term interest rate, a supplier discount, and an issuer rebate.

19. The computing device of claim 17 wherein information related to the type of savings report selected when the type of savings report selected is the corporate card program comprises a total annual spending on travel, current corporate card program spending, a percentage of travel budget being spent on airfare, lodging, auto rental, restaurant, entertainment, and miscellaneous sources, conversion targets for predetermined time periods, a number of total manual expense reports processed annually, a percentage of manual expense reports that could be automated, total number of cash advances processed annually, a percent of cash advances that could be eliminated, a supplier discount, and an issuer rebate.

20. The computing device of claim 11 wherein the computing device is a mobile device.
